(19) United States
(12) Patent Application Publication
(10) Pub. No.: US 2024/0181603 A1
(43) Pub. Date: Jun. 6, 2024

(54) CLAMPING APPARATUS AND CONTACT APPARATUS FOR A PLATE AND METHOD FOR CLAMPING AT LEAST ONE WORKPIECE BETWEEN A CLAMPING APPARATUS AND A CONTACT APPARATUS.

(71) Applicant: BESSEY Tool GmbH & Co. KG, Bietigheim-Bissingen (DE)

(72) Inventors: Valentin Sawizki, Erlenbach (DE); Gerhard Kloepfer, Pleidelsheim (DE)

(21) Appl. No.: 18/419,868

(22) Filed: Jan. 23, 2024

Related U.S. Application Data
(63) Continuation of application No. PCT/EP22/70907, filed on Jul. 26, 2022.

(30) Foreign Application Priority Data
Aug. 13, 2021 (DE) 10-2021-121-140.9
Nov. 19, 2021 (DE) 10 2021 130 373.7

(51) Int. Cl. B25B 5/02; B25B 5/16

(52) U.S. Cl. CPC B25B 5/02; B25B 5/166

(57) ABSTRACT

Provided is a clamping apparatus for a plate, comprising a holding body at which a bolt is arranged for entering into an opening of the plate, a clamping rail which is linearly displaceable relative to the holding body along a displacement axis, and a pressure piece which is arranged or formed at the clamping rail, wherein the clamping rail is guided for linear displacement on a guide element which is movably supported on the holding body, and wherein the guide element is supported for height movement such that a height distance of the pressure piece to the bolt and/or to the holding body is dependent on a position of the guide element relative to the holding body, wherein the height distance is transverse to the displacement axis of the clamping rail.

This application is a continuation of international application number PCT/EP2022/070907 filed on 26 Jul. 2022 and claims the benefit of German application numbers 10 2021 121 140.9 filed on 13 Aug. 2021 and 10 2021 130 373.7 filed on 19 Nov. 2021, which are incorporated herein by reference in their entirety and for all purposes.

### BACKGROUND OF THE INVENTION

The invention relates to a clamping apparatus for a plate, comprising a holding body at which a bolt is arranged for entering into an opening of the plate, a clamping rail which is linearly displaceable relative to the holding body along a displacement axis, and a pressure piece which is arranged or formed at the clamping rail.

The invention further relates to a clamping apparatus for a plate, comprising a holding body at which a bolt is arranged for entering into an opening of the plate, a clamping rail which is linearly displaceable relative to the holding body along a displacement axis, and a clamping lever for actuating a displacement movement of the clamping rail.

Furthermore, the invention relates to a contact apparatus for a plate, comprising a holding body, a bolt which is arranged at the holding body and is provided for entering into an opening of the plate, and a contact element having a contact surface for a workpiece.

Furthermore, the invention relates to a method for clamping at least one workpiece between a clamping apparatus and a contact apparatus against a plate, wherein the clamping apparatus comprises a first holding body, a first bolt which is arranged at the first holding body, and a first contact region for at least one workpiece, and wherein the bolt is entered into a first opening of the plate, and wherein the contact apparatus comprises a second holding body, a second bolt which is arranged at the second holding body, and a second contact region for at least one workpiece, and wherein the second bolt is entered into a second opening of the plate.

The plate can be part of a multifunction table. The plate is provided with openings for having bolts entered thereinto. A corresponding clamping apparatus is then also referred to as an MFT clamping apparatus.

In accordance with an embodiment of the invention, provided is a clamping apparatus of the kind mentioned at the outset, which clamping apparatus can be securely fixed against the plate when a workpiece is clamped and in which the workpiece is largely prevented from lifting off when a workpiece is clamped.

### SUMMARY OF THE INVENTION

In accordance with an embodiment of the invention, provision is made that the clamping rail is guided for linear displacement on a guide element which is movably supported on the holding body, and in that the guide element is supported for height movement such that a height distance of the pressure piece to the bolt and/or to the holding body is dependent on a position of the guide element relative to the holding body, wherein the height distance is transverse to the displacement axis of the clamping rail.

A guide element is provided for the clamping rail, which guide element is heightwise movable relative to the holding body. By virtue of the guide element, the clamping rail, and hence the pressure piece, is given a further degree of freedom of movement, namely the height mobility, in addition to its capability for linear displacement along the displacement axis.

Such additional degree of freedom of movement enables the pressure piece to be moved in a direction towards the plate when a workpiece is clamped against the plate. This mobility at the clamping apparatus generates a hold-down force for clamped workpieces. Such hold-down force largely prevents workpieces from lifting off and improves fixation against the plate. Thus, in turn, a workpiece can be more accurately and securely clamped in place against the plate via the clamping apparatus—with no danger of lift off.

In particular, provision is made for the guide element to be supported for height movement on the holding body such that the height distance of the pressure piece to the bolt and/or to the holding body is smaller in a clamped state in which the clamping apparatus exerts a clamping force upon a workpiece than in an unclamped state in which the clamping apparatus does not exert a clamping force. It is thereby possible to generate in a clamped state a hold-down force which urges the clamping apparatus against the plate.

It is advantageous for the guide element to be heightwise movable relative to the holding body such that when in a clamped state in which the clamping apparatus exerts a clamping force upon a workpiece, a hold-down force is exerted on the workpiece. The clamping apparatus is thereby urged against the plate and the bolt is correspondingly urged into the opening in which it is already entered. In this way, workpieces are largely prevented from lifting off. This results in improved fixability of workpieces against the plate. Thus, in turn, a workpiece can be more securely clamped in place against the plate via the clamping apparatus.

In particular, provision is made for the bolt to extend along a height axis, wherein the height distance is parallel to the height axis, and for the guide element to be supported for height movement on the holding body such that, via the guide element, the pressure piece has a mobility component parallel to the height axis. This provides a simple way of generating a hold-down force in a direction towards the plate when a workpiece is clamped, wherein the pressure piece acts upon the workpiece.

It is advantageous for the guide element to be pivotably or displaceably supported relative the holding body. It is thereby possible, via the guide element, to achieve a mobility component of the pressure piece in a height direction with simple structure. This in turn provides a simple way of generating a hold-down force when a workpiece is clamped.

Here, it is possible, via the heightwise movable guide element, for the clamping rail to be pivotable relative to the bolt and/or relative to the holding body, or for it to be heightwise displaceable as a whole, or to be heightwise displaceable in one or more portions thereof. By virtue of a pivotability or by virtue of a height displaceability in one or more portions, an angular position of the clamping rail, for example with respect to a horizontal axis or with respect to a planar surface of the plate, can be changed in a clamping operation in order to generate a hold-down force. The horizontal axis is, for example, an axis that is parallel to a contact surface of the holding body against the plate. It is also possible, via the heightwise movable guide element, for the clamping rail to be heightwise displaceably supported as a whole with respect to the holding body. This is another way of generating a hold-down force in a clamping operation. In particular, the hold-down force is then transmitted via the guide element to the holding body or to the bolt and the clamping apparatus as a whole is urged against the plate.

Here, it is possible, via the heightwise movable guide element, for an angular position of the clamping rail relative to the bolt and/or to the holding body to be variable, particularly with at least one of the following:
in a clamped state in which the clamping apparatus exerts a clamping force upon a workpiece, the clamping rail lies with its displacement axis at an acute angle to a horizontal axis of the holding body;
a maximum acute angle of the clamping rail relative to a horizontal axis of the holding body is such that the clamping rail or the pressure piece will not in any displacement position of the clamping rail project beyond an underside of the holding body which underside is provided for contact of the holding body against the plate;
a maximum acute angle relative to the horizontal axis is less than or equal to 15°, and in particular less than or equal to 10°, and in particular less than or equal to 7°, and in particular less than or equal to 6°, and in particular less than or equal to 5°.

An angular position of the clamping rail can be changed via a pivotable (and, thereby, heightwise movable) guide element or via a guide element heightwise displaceable in portions thereof (and which can also be heightwise displaceable to a differing extent in different portions thereof). In particular, the effect can thereby be achieved that, in a clamping state of the clamping apparatus in which a workpiece is clamped and a corresponding pressure force is exerted upon the workpiece by way of the pressure piece, the angular position differs from that in a non-clamping state. A hold-down force can thereby be generated in the clamped state.

Correspondingly, it is advantageous if, when in a clamped state (clamping state), the clamping rail lies with its displacement axis at an acute angle with respect to a horizontal axis of the holding body. In particular, the horizontal axis of the holding body is an axis which is parallel to a contact surface of the holding body against the plate. In the case of a planar plate and when the holding body is correctly positioned, the horizontal axis is in particular parallel to a surface of the plate. A hold-down force can be achieved via the acute angle in the clamped state.

It is then advantageous for the maximum acute angle to not exceed a maximum magnitude in order, in particular, to prevent the pressure piece or the clamping rail from striking the plate before making contact against a workpiece. The clamping rail or the pressure piece is not to project beyond an underside of the holding body in any displacement position of the clamping rail.

It has proven advantageous for the corresponding acute angle to be less than or equal to 15°, and in particular less than or equal to 10°, and in particular less than or equal to 7°, and in particular less than or equal to 6° and in particular less than or equal to 5°. In a concrete exemplary embodiment, said angle is about 4.5°. In principle, the acute angle can have a large magnitude if the holding body is sized with a height in the height direction of correspondingly large dimensions. In order to achieve compact dimensions, on the other hand, it is then advantageous for the maximum acute angle to be small. In order to achieve a hold-down force of sufficient magnitude, it is desirable for the maximum acute angle to be large. The values specified above allow an optimized tradeoff between dimensions of the clamping apparatus (in particular height) and sufficient holding force.

In an embodiment, the guide element is pivotably supported on the holding body via a pivot bearing, in particular with at least one of the following:
a pivot axis of the pivot bearing is oriented transversely and in particular perpendicularly to the displacement axis of the clamping rail;
a pivot axis of the pivot bearing is oriented transversely and in particular perpendicularly to a direction of the height distance;
a pivot axis of the pivot bearing is oriented transversely and in particular perpendicularly to a height axis of the bolt;
the guide element is configured in the form of a rocker;
the clamping rail is positioned between the pivot bearing and the bolt, with respect to the height distance;
the pivot bearing is arranged such that a projection of the pivot bearing in a direction of the height distance lies on the bolt or at a distance transverse to a height axis of the bolt of less than 2 cm from the bolt.

A pivotable guide element can be implemented with simple structure. Via the pivotability, a height mobility component of the guide element, and hence of the clamping rail, and hence, in turn, of the pressure piece, can be achieved. A distance of the pressure piece to the bolt can be varied, relative to the height direction. This is achieved by the corresponding orientation of the pivot axis. When the guide element is configured in the form of a rocker, it can be configured for simple construction. When the clamping rail is positioned between the pivot bearing and the bolt, the effect can thereby be achieved in a simple manner that a height mobility of the pressure piece is implemented via the pivotability of the guide element. With a projection of the pivot axis in a direction of the height distance lying on the bolt or at a small distance to same, the occurrence of disturbing tilting moments at the clamping apparatus is obviated.

In an alternative embodiment, the guide element is heightwise displaceable relative to the holding body and is supported for displacement relative to the holding body in a direction transverse to the displacement axis of the clamping rail. A height mobility component of the clamping rail, and hence of the pressure piece, can thereby be obtained.

It is then advantageous for a displacement bearing to be provided on which the guide element is supported for displacement relative to the holding body. The guide element is then configured as a slide, wherein said slide is displaceable, and in particular linearly displaceable in one or more linear directions, relative to the holding body.

In an embodiment with simple structure, the displacement bearing has at least one elongated hole on which a pin is guided, wherein (i) the pin is connected to the guide element in translationally fixed relation thereto and the at least one elongated hole is translationally fixed relative to the holding body, or (ii) the pin is translationally fixed relative to the holding body and the at least one elongated hole is connected in translationally fixed relation to the guide element. By the use of one or more elongated hole guides, a simple way of realizing a displacement bearing, and in particular as a sliding bearing, is provided. The guide element can then be formed as a slide in a simple manner, which slide is supported for displacement relative to the holding body. The displacement bearing is arranged directly at the holding body or, for example, at a housing which is fixedly connected to the holding body or which is formed at the holding body.

In particular, it is advantageous for at least one of the following to be provided:
a plurality of elongated holes are provided which are spaced apart in a direction parallel to the displacement axis of the clamping rail;
an elongated hole has an elongated hole axis which is arranged at an acute angle to a horizontal axis of the holding body, in particular wherein the acute angle is in the range between 2° and 25°;
(i) in the case of a plurality of elongated holes, these have identical configurations and an angular position of the clamping rail relative to the bolt does not change when the guide element is displaced heightwise, or (ii) in the case of a plurality of elongated holes, these are arranged and/or formed differently and an angular position of the clamping rail relative to the bolt changes when the guide element is displaced heightwise;
the guide element has a movement component parallel to the horizontal axis of the holding body;
the at least one elongated hole is arranged at a housing which is connected to the holding body or is part of the holding body.

By the provision of a plurality of elongated holes, stable support of the guide element relative to the holding body is achieved. In particular, a first set of opposing elongated holes is provided, wherein the clamping rail is positioned between the opposing elongated holes. Further, a second set of elongated holes is provided, wherein the clamping rail is again positioned between the elongated holes of the second set. The first set of elongated holes and the second set of elongated holes are in spaced relation to each other relative to a longitudinal direction of the clamping rail. A “four-point support” of the guide element relative to the holding body can thereby be achieved.

When an elongated hole has an elongated hole axis which is arranged at an acute angle to a horizontal axis of the holding body, then, by a displacement movement in a direction at least approximately parallel to the horizontal axis, a heightwise displacement can additionally be effected. In turn, the height distance of the pressure piece relative to the bolt can thereby be changed and a hold-down force can be generated in a clamped state.

Here, it is possible, by corresponding arrangement of a plurality of elongated holes, that the angular position of the clamping rail does not change when the height distance changes, or that the angular position does change. If the elongated holes have parallel axes, then the angular position does not normally change. If the elongated hole axes are not parallel, the angular position can be changed.

A configuration with simple construction is afforded when the guide element has a movement component that is parallel to the horizontal axis of the holding body. The guide element then has, via the displacement support, a movement component that is perpendicular to the horizontal axis of the holding body. This height component of the movement enables the pressure piece to be lowered relative to the bolt in a clamped state compared with the unclamped state, and the hold-down force can be generated.

Simple construction is afforded when the at least one elongated hole is arranged at a housing which is connected to the holding body or is part of the holding body.

It is particularly advantageous for the holding body to have an underside with a contact surface for contact against the plate, wherein the bolt extends transversely away from the underside, in particular with at least one of the following:
the contact surface is a planar surface;
the contact surface is parallel to a horizontal axis relative to which the bolt is oriented transversely and in particular perpendicularly.

This provides a way of securely clamping workpieces against the plate. By virtue of the bolt in the opening of the plate, the clamping apparatus can be fixed in a form-locking manner with respect to the plate, relative to a direction transverse to the height axis of the bolt. By virtue of the contact surface, and in particular the planar surface on the underside of the holding body, a form-locking connection in a downward direction towards the plate is achieved by the plate.

Ease of operability is afforded when a clamping lever is provided which is pivotable relative to the holding body, in particular with at least one of the following:
a pivot axis of the clamping lever is oriented transversely to the displacement axis of the clamping rail;
a pivot axis of the clamping lever is oriented parallel or at an acute angle of less than 15° relative to a height axis of the bolt;
a pivot axis of the clamping lever is oriented transversely to a contact surface of the holding body against the plate.

The clamping lever is thereby rendered easy to operate for an operator. In particular, the operator can pivot the clamping lever from a position above the plate without the clamping lever coming into contact with the plate.

In an exemplary embodiment, the clamping lever is arranged at the guide element and is movable with the guide element. This can provide structural benefits.

Alternatively, it is possible for the clamping lever to be located at the holding body and for the guide element to be (at least) heightwise movable relative to the clamping lever.

It is particularly advantageous for the clamping lever to have at least a first position in which a displacement movement of the clamping rail along the displacement axis is released, and to have a second position which is a blocking position in which the displacement of the clamping rail in a backward direction is blocked. It is then possible for example, when the clamping lever is in the first position, for an operator to freely displace the clamping rail and, for example, to displace same in such way that the pressure piece is in contact against a workpiece to be clamped or is positioned just ahead of the workpiece. The second position is a blocking position by which, in particular, a displaceability of the clamping rail in a backward direction can be blocked. A clamped position of a workpiece can thereby be secured.

It is particularly advantageous if, when in the second position, a movement of the clamping lever out of the second position is blocked, and in particular a self-locking mechanism is provided for blocking the second position. This provides a way of effectively preventing an in particular unintentional release of a clamping position of a workpiece. An operator, in turn, is able to unblock the blocking action under exertion of increased force to move the clamping lever out of the second position.

It is advantageous for at least one advance element to be provided which is associated with the clamping lever and via which the clamping lever acts upon the clamping rail, in particular with at least one of the following:
the clamping rail is passed through an opening of the at least one advance element;
the at least one advance element is configured in the form of a plate, and in particular a sheet metal plate;
in a first position of the clamping lever, the at least one advance element is positioned such that the clamping rail is freely displaceable along the displacement axis;
starting from the first position of the clamping lever, a pivoting of the clamping lever effects canting of the at least one advance element relative to the clamping rail and effects advancement of the at least one advance element, and hence of the clamping rail along the displacement axis.

Via the advance element, the clamping lever acts upon the clamping rail in order to displace same. Furthermore, via the advance element, a backward movement of the clamping rail (with the pressure piece moving in a direction towards the holding body) can be blocked. Here, exactly one advance element can be provided or an advance element package comprising a plurality of advance elements can be provided, these being arranged in particular such that they contact each other. The advance element package can comprise two advance elements or more than two advance elements.

By passage of the clamping rail through an opening of the at least one advance element, a simple way is provided of achieving canting thereof for carrying the clamping rail along by the advance element and achieving a blocking action. Furthermore, this provides a simple way of unblocking the blocked condition.

By the configuration as a plate, and particularly as a sheet metal plate, the at least one advance element can be configured and manufactured with simple structure.

In a first position of the clamping lever, the at least one advance element is positioned such that the clamping rail is freely movable along the displacement axis thereof. Thus, with the clamping lever in the first position, a simple way is provided for an operator to position the pressure piece arbitrarily relative to a workpiece by corresponding displacement of the clamping rail.

By the pivoting of the clamping lever starting from the first position, canting of the at least one advance element relative to the clamping rail is effected. The clamping rail can then be moved and displaced along the displacement axis by movement of the advance element. Furthermore, a backward displacement of the clamping rail can be blocked via the canted advance element. This provides a simple way of exerting a corresponding clamping force upon a workpiece, and the workpiece, or a plurality of workpieces, can be clamped against the plate via the clamping apparatus.

In an embodiment of simple construction, an operative element is connected to the clamping lever in rotationally fixed relation therewith, which operative element acts upon the at least one advance element, wherein the operative element effects canting of the at least one advance element relative to the clamping rail and effects longitudinal displacement of the clamping rail in the displacement axis. This arrangement affords simple construction and provides a simple way of effecting a clamping action.

In an exemplary embodiment, the operative element acts directly upon the at least one advance element, and in particular contacts same. Preferably, direct contact exists between the operative element and the at least one advance element.

Alternatively, provision can be made for the operative element to act directly upon the guide element, and in particular to contact the guide element, wherein the guide element then acts directly on the at least one advance element, and in particular contacts same, and wherein the operative element effects longitudinal displacement of the guide element, in particular wherein a longitudinal displacement of the guide element is parallel to the displacement axis of the clamping rail. A longitudinal displacement of the guide element then first effects canting of the at least one advance element, followed by carrying along the at least one advance element along the displacement axis of the clamping rail, which in turn effects displacement of the clamping rail.

It is particularly advantageous for the operative element to be configured as an eccentric. Rotation of the clamping lever with the operative element can then be converted to linear displacement of the at least one advance element, and hence of the clamping rail. Furthermore, this provides a simple way of achieving canting of the at least one advance element, starting from a non-canted state thereof.

It is then advantageous for at least one of the following to be provided:
the operative element is rotatably supported on a rotary bearing which is in particular a sliding bearing;
the operative element has an outer contour which is in particular cylindrical;
the operative element has a cutout, wherein, in a first position of the clamping lever, a region of the guide element or the at least one advance element lies in the cutout and is in particular in contact against a wall of the cutout, wherein in the first position of the clamping lever, the at least one advance element is non-canted relative to the clamping rail;
in the first position of the clamping lever, the wall is oriented perpendicularly to the clamping rail;
the wall has a planar configuration, and, in particular, a movement of the clamping lever out of the first position effects movement of the wall and an eccentric action upon the at least one advance element, which causes the at least one advance element to be canted relative to the clamping rail and causes the at least one advance element to be displaced;
the cutout has a shape of a segment of a circle;
a second position of the clamping lever is defined by the at least one advance element being in contact against an outer contour of the operative element, outside the cutout.

By the rotatable support of the operative element on the rotary bearing, a stable configuration is achieved and optimized application of force by an operator is achieved by manipulation of the clamping lever.

By virtue of the cylindrical outer contour, a simple way is provided of achieving a blocking position of the clamping lever.

The cutout provides a simple way of configuring the operative element as an eccentric. This makes for a simple way of also defining a first position by having the operative element in contact against the corresponding wall and the clamping rail freely movable.

At the transition from the action of the wall of the cutout upon the operative element to the cylindrical outer contour, a kind of potential valley can be achieved, or a dead center point can be reached, in particular in order to predetermine a second position of the clamping lever (blocking position).

Furthermore, it is advantageous for at least one of the following to be provided:
the clamping lever is positioned above the holding body, relative to a height direction of the height distance;
when the clamping apparatus is fixed against the plate, a pivoting plane of the clamping lever is parallel to a table plane of the plate or lies at an acute angle of less than 10° to the table plane.

By this arrangement, it is rendered easy for an operator to operate the clamping lever, and in particular to operate the clamping lever at least approximately parallel to the surface of the plate.

It is particularly advantageous for the guide element to be supported relative to the holding body via at least one spring device. By the use of the at least one spring device, a number of different functionalities can be achieved. Thus, for example, a first position of the guide element or of a clamping lever can be secured and said first position can be automatically reached. A spring device, when correspondingly configured, can also be utilized to predetermine a clamping force.

In an exemplary embodiment, a first spring device is arranged and configured such that it holds the guide element and/or an advance element in a first position which is a non-clamping position and in which the clamping rail is freely displaceable, and a spring force of the first spring device must be overcome in order to effect movement out the first position. Automatic transition to said first position can thereby be achieved, in particular if no blocked condition exists of, for example, a clamping lever. Here, the expression “first spring device” does not mean that a plurality of spring devices are to be provided.

In an exemplary embodiment, a second spring device is arranged and configured such that, in a clamping position, the guide element is supported on the holding body via the second spring device and the second spring device is tensioned. Here, the expression “second spring device” is not to be understood to mean a numerical term. It does not necessarily mean that a plurality of different spring devices need be present. Via the second spring device, a clamping force applied in the clamping position can be predetermined.

It is then advantageous for a spring force of the second spring device to be fixably adjustable, in particular with at least one of the following:
a contact element is provided for the second spring device, which contact element is arranged at the holding body and which is fixably adjustable in its position relative to the holding body;
the clamping rail is passed through the contact element;
the contact element can be operated from outside the holding body;
the contact element is configured as a rotary element and in particular as a union nut.

By virtue of the fixable adjustment which acts upon the second spring device, a clamping force applied in the clamping position can be adjusted.

By the provision of the contact element, the adjustability feature can be provided with simple construction. This affords ease of operability, in particular from outside the holding body.

In an embodiment, provision is made for the bolt to be fixably removably arranged at the holding body. This affords the possibility of accommodating different opening sizes using the same basic structure of the clamping apparatus with the holding body and the guide element. The bolts are then exchanged accordingly. Bolts of different lengths and/or diameters can then be employed.

In an advantageous embodiment, an insertion guide is arranged at the holding body and the bolt has a counter element to the insertion guide, wherein, when the counter element is arranged in the insertion guide, the bolt is held in place to the holding body, and in particular wherein an insertion direction and retraction direction for the counter element of the bolt is oriented transversely to the displacement axis of the clamping rail, relative to the insertion guide. In particular, the counter element is then configured such that it is in contact against the plate so that the bolt cannot fall through a corresponding opening. It is then possible for the bolt with the counter element to be inserted into an opening in the plate and to then have the holding body slid thereonto. When the insertion direction and retraction direction for the counter element of the bolt, in relation to the insertion guide, is oriented transversely to the displacement axis of the clamping rail, a clamping force which is applied on a workpiece via the clamping rail is unable to release the bolt from the holding body.

It is also possible for example for the bolt to be fixably removably held in place to the holding body via a threaded connection.

In particular, provision is made for the clamping apparatus to comprise a set of bolts, wherein different bolts have different diameters and/or different lengths. This provides a way of using the clamping apparatus with the set of bolts for different plates with differently configured openings.

In an advantageous embodiment, the bolt has at least a first segment and a second segment, and an expanding element is arranged at the guide element, which expanding element is heightwise movable with the guide element, and the expanding element is positioned between the first segment and the second segment of the bolt. By the expanding element, the bolt can be expanded and clamped against an opening. Additional fixation of the clamping apparatus against the plate can thereby be achieved. The expanding element is coupled to the guide element, particularly so that an expansion process can be carried out via a corresponding height mobility of the guide element. It is thereby possible, by virtue of the height mobility of the guide element that generates a hold-down force, to additionally implement clamping of the bolt within the opening.

In an exemplary embodiment, the expanding element is arranged and formed such that a height movement of the guide element in a direction towards the bolt causes the bolt to expand transversely to a direction of insertion of the bolt into the associated opening of the plate. Thus, besides the hold-down force, it is then also possible to achieve expansion and clamping of the bolt against an opening of the plate.

By way of example, a clamping lever is connected to the guide element in rotationally fixed relation therewith. The guide element can be displaced heightwise by imparting rotation to the clamping lever. This then also effects expansion of the bolt.

In an embodiment with simple construction, the guide element is rotatably arranged on the holding body, in particular with at least one of the following:
an axis of rotation of the guide element is transverse to the displacement axis of the clamping rail;
an axis of rotation of the guide element is at least approximately parallel to a direction of the height distance;
an axis of rotation of the guide element is at least approximately parallel to a height axis of the bolt;
an axis of rotation of the guide element is at least approximately parallel to a direction of insertion of the bolt into the opening of the plate.

This provides a simple way of achieving height displacement of the guide element by rotation of the guide element, in particular via a clamping lever.

In an embodiment with simple construction, the guide element is supported on the holding body via a thread, and via a trapezoidal thread in particular.

In particular, provision is made for the expanding element to be connected in rotationally fixed relation to a clamping lever or to the guide element, wherein a pivoting movement of the clamping lever out of a first position in which first position the clamping rail is freely displaceable relative to the guide element, has the following effects:
lowers the expanding element in a height direction;
expands the bolt;
cants at least one advance element relative to the clamping rail;
advances the at least one advance element and thereby advances the clamping rail.

This then permits, by rotation of the clamping lever, a plurality of operations to be carried out at the clamping apparatus, namely lowering of the expanding element in a height direction which effects expansion of the bolt, canting of at least one advance element relative to the clamping rail and, then, advancement of the at least one advance element and, thereby, advancement of the clamping rail.

It is advantageous for a disc element to be arranged at the guide element and/or at the clamping lever, which disc element is in particular configured as an eccentric and which acts upon at least one advance element for the clamping rail and in particular directly contacts the at least one advance element. This provides a simple way of displacing the clamping rail in a forward direction, wherein a backward movement is blocked.

In accordance with an embodiment of the invention, provision is made that the bolt has at least a first segment and a second segment, and in that the clamping lever has associated therewith an expanding element which is arranged between the first segment and the second segment of the bolt, and in that the expanding element is coupled to the clamping lever such that pivoting movement of the clamping lever effects expansion of the bolt by the expanding element.

By rotation of the expanding element and/or height movement of the expanding element, the expanding element moves relative to the bolt such that expansion occurs. This movement of the expanding element is in turn achieved by the clamping lever. The clamping lever in turn effects a clamping action by pivotal movement. In this way, expansion of the bolt can thereby, in a sense, be automatically achieved in the clamping operation. Clamping of the bolt within an opening of the plate can thereby be achieved. The fixation of the clamping apparatus against the plate, and hence in turn clamping of a workpiece against the plate, is thereby improved.

In an exemplary embodiment, the expanding element is supported on the holding body for height movement with respect to a height axis. Here, the expanding element can additionally be rotatable. In principle, it is also possible for the expanding element to be supported on the holding body for rotational movement alone.

In particular, the expanding element is arranged and configured such that the height movement in a direction towards the plate effects expansion of the bolt transversely to a direction of insertion of the bolt into the associated opening.

In an exemplary embodiment, the expanding element is connected to the clamping lever in rotationally fixed relation therewith. This makes for a simple construction. The mere rotation of the expanding element can accomplish the expansion of the bolt with use of, for example, a corresponding sliding block guide.

In particular, the clamping lever is rotatably arranged relative to the holding body. This makes for a configuration with simple construction.

When the clamping lever is supported on the holding body via a thread, and in particular trapezoidal thread, this can provide a simple way of, for example, achieving additional displacement in the height direction.

In particular, a rotary movement of the clamping lever out of a first position in which the clamping rail is freely displaceable has the following effects:
moves the expanding element with action on the bolt and, for example, lowers the expanding element in a height direction;
expands the bolt;
cants at least one advance element relative to the clamping rail;
advances the at least one advance element and thereby advances the clamping rail.

It is then possible for an operator to achieve by a single movement both clamping of a workpiece via the clamping apparatus and clamping of the bolt against an opening of the plate. Here, it is not absolutely necessary for the expanding element to be lowered in a height direction for an expanding action to occur. In principle, rotational movement alone of the expanding element at the bolt is sufficient to achieve expansion of the bolt when correspondingly configured with, for example, a sliding block guide.

In an embodiment, a disc element is connected to the clamping lever, which disc element is in particular formed as an eccentric and which acts on at least one advance element for the clamping rail, and in particular directly contacts the at least one advance element. This provides a simple way of achieving, via the clamping lever, a canting of the at least one advance element relative to the clamping rail and a forward movement of the clamping rail, wherein a backward movement can be blocked at the same time.

In accordance with an embodiment of the invention, provided is a contact apparatus of the kind mentioned at the outset, which contact apparatus can be securely fixed against the plate.

In accordance with an embodiment of the invention, provision is made that the contact element is supported for height movement on the holding body, wherein, relative to a height axis, a height distance of the contact surface to the bolt and/or to the holding body is variable.

By virtue of the height mobility of the contact element relative to the holding body, it is possible in a clamping state, when a workpiece is clamped between the contact apparatus and a clamping apparatus, to generate at the contact apparatus a hold-down force in a direction towards the plate. The contact apparatus is thereby additionally urged against the plate and this achieves stable fixation of the contact apparatus against the plate. This in turn provides stable clamping of a workpiece against the plate.

In an embodiment, the contact element is pivotable via a pivot bearing, or in an alternative embodiment, the contact element is supported for height displacement relative to the holding body via a displacement bearing. Height mobility of the contact element can thereby be realized in order to generate a hold-down force when in a clamping state.

When a displacement bearing is used, it is advantageous from a construction perspective for the displacement bearing to have at least one elongated hole and for the contact element to be supported for displacement relative to the holding body in a direction transverse to the height axis. In this way, the contact element is formed as a slide, wherein said slide is displaceable in two mutually perpendicular directions relative to the holding body.

In an advantageous embodiment, a spring device is provided by way of which the contact element is supported on the holding body, wherein the spring device holds the contact element in a first position and a spring force of the spring device needs to be overcome for moving the contact element out of the first position. Here, in particular, the spring force is overcome in a clamping operation by the pressure force of a clamping apparatus. The spring device also ensures that the contact element, of its own accord, returns to its initial position (the first position).

It is advantageous for the contact element to be heightwise movable such that in a heightwise moved position of the contact element (as opposed to an initial position thereof), a hold-down force acts upon the holding body and/or upon the bolt. A hold-down force of the contact element in a direction towards the plate can thereby be achieved when in a clamped state and the fixation of workpieces against the plate can be enhanced.

In an exemplary embodiment, the contact element has a (marked) second position in which the contact element has a maximum height position relative to a first position, wherein the contact surface is, in the height axis, in closer proximity to the bolt and/or to the holding body in the second position than in the first position. A hold-down force can thereby be generated.

In particular, a contact device is provided which predetermines the first position and/or the second position of the contact element by contact of the contact element and wherein the contact device is arranged or formed at the holding body. A maximum range of movement of the contact element relative to the holding body can thereby be defined.

In accordance with an embodiment of the invention, a method of the type mentioned at the outset is provided, with which method workpieces between the clamping apparatus and the contact apparatus can be fixed to a plate in a simple and secure manner.

In accordance with an embodiment of the invention, at least one of the following is provided:
the first contact region is heightwise movable relative to the first holding body and/or relative to the first bolt, and a hold-down force is generated at the clamping apparatus in a direction towards the plate when the at least one workpiece is clamped;
the second contact region is heightwise movable relative to the second holding body, and a hold-down force is generated at the contact apparatus in a direction towards the plate when the at least one workpiece is clamped;
the first bolt is expandable and expansion is effected when the at least one workpiece is clamped.

In particular, the method in accordance with the invention can be carried out with the clamping apparatus in accordance with the invention and/or with the contact apparatus in accordance with the invention.

A hold-down force can be generated at the clamping apparatus and/or at the contact apparatus when one or more workpieces are clamped, which hold-down force enhances the fixation.

Alternatively or in addition, in the clamping operation, the first bolt is expanded and can then be clamped against an opening in the plate.

Here, in particular, a clamping of the at least one workpiece between the contact apparatus and the clamping apparatus is actuated via a clamping lever at the clamping apparatus. Simplicity of operation is thereby achieved. Via the clamping lever, a clamping rail can be displaced and, with a pressure piece thereof, urged against a workpiece. Here, via the clamping lever, it is further possible to realize a “synchronous” height movement of the pressure piece for generating a hold-down force or, alternatively or additionally, to effect expansion of the first bolt.

The following description of preferred embodiments serves in conjunction with the drawings to explain the invention in greater detail.

### BRIEF DESCRIPTION OF THE DRAWINGS

FIGS. 1 to 12 show a first exemplary embodiment of a clamping apparatus in accordance with the invention, wherein:

FIG. 1 shows a side view of the clamping apparatus, shown as being in an unclamped state;

FIG. 2 shows a top view of the clamping apparatus in accordance with the invention, when viewed in the direction A of FIG. 1;

FIG. 3 shows a top view of the clamping apparatus of FIG. 1, when viewed in the direction B of FIG. 2;

FIG. 4 shows a perspective representation of the clamping apparatus of FIG. 1;

FIG. 5 shows the same view as FIG. 1, except in a clamping position;

FIG. 6 shows the same view as FIG. 2, except in a clamping position;

FIG. 7 shows the same view as FIG. 3, except in a clamping position;

FIG. 8 shows the same view as FIG. 4, except in a clamping position;

FIG. 9 shows a sectional view taken along line 9-9 of FIG. 2 (unclamped position);

FIG. 10 shows a sectional view taken along line 10-10 of FIG. 6 (clamping position);

FIG. 11 shows a sectional view taken along line 11-11 of FIG. 1 (unclamped position);

FIG. 12 shows a sectional view taken along line 12-12 of FIG. 5 (clamping position);

FIGS. 13 to 24 show a second exemplary embodiment of a clamping apparatus in accordance with the invention, wherein:

FIG. 13 shows a side view of the clamping apparatus, shown as being in an unclamped state;

FIG. 14 shows a top view of the clamping apparatus of FIG. 13, when viewed in the direction A of FIG. 13;

FIG. 15 shows a top view of the clamping apparatus of FIG. 13, when viewed in the direction B of FIG. 14;

FIG. 16 shows a perspective representation of the clamping apparatus of FIG. 13;

FIG. 17 shows the same view as FIG. 13, except in a clamping position;

FIG. 18 shows the same view as FIG. 14, except in a clamping position;

FIG. 19 shows the same view as FIG. 15, except in a clamping position;

FIG. 20 shows the same view as FIG. 16, except in a clamping position;

FIG. 21 shows a sectional view taken along line 21-21 of FIG. 14 (unclamped position);

FIG. 22 shows a sectional view taken along line 22-22 of FIG. 18 (clamping position);

FIG. 23 shows a sectional view taken along line 23-23 of FIG. 13 (unclamped position);

FIG. 24 shows a sectional view taken along line 24-24 of FIG. 17 (clamping position);

FIGS. 25 to 36 show a third exemplary embodiment of a clamping apparatus in accordance with the invention, wherein:

FIG. 25 shows a side view of the clamping apparatus, shown as being in an unclamped state;

FIG. 26 shows a top view of the clamping apparatus of FIG. 25, when viewed in the direction A of FIG. 25;

FIG. 27 shows a top view of the clamping apparatus of FIG. 25, when viewed in the direction B of FIG. 26;

FIG. 28 shows a perspective representation of the clamping apparatus of FIG. 25;

FIG. 29 shows the same view as FIG. 25, except in a clamping position;

FIG. 30 shows the same view as FIG. 26, except in a clamping position;

FIG. 31 shows the same view as FIG. 27, except in a clamping position;

FIG. 32 shows the same view as FIG. 28, except in a clamping position;

FIG. 33 shows a sectional view taken along line 33-33 of FIG. 26 (unclamped position);

FIG. 34 shows a sectional view taken along line 34-34 of FIG. 30 (clamping position);

FIG. 35 shows a sectional view taken along line 35-35 of FIG. 25 (unclamped position);

FIG. 36 shows a sectional view taken along line 36-36 of FIG. 29 (clamping position);

FIGS. 37 to 49 show a fourth exemplary embodiment of a clamping apparatus in accordance with the invention, wherein:

FIG. 37 shows a side view of the clamping apparatus, shown as being in an unclamped state;

FIG. 38 shows a top view of the clamping apparatus of FIG. 37, when viewed in the direction A of FIG. 37;

FIG. 39 shows a top view of the clamping apparatus of FIG. 37, when viewed in the direction B of FIG. 38;

FIG. 40 shows a perspective representation of the clamping apparatus of FIG. 37;

FIG. 41 shows the same view as FIG. 37, except in a clamping position;

FIG. 42 shows the same view as FIG. 38, except in a clamping position;

FIG. 43 shows the same view as FIG. 39, except in a clamping position;

FIG. 44 shows the same view as FIG. 40, except in a clamping position;

FIG. 45 shows a sectional view taken along line 45-45 of FIG. 38 (unclamped position);

FIG. 46 shows a sectional view taken along line 46-46 of FIG. 38 (unclamped position);

FIG. 47 shows a sectional view taken along line 47-47 of FIG. 42 (clamping position);

FIG. 48 shows a sectional view taken along line 48-48 of FIG. 37 (unclamped position);

FIG. 49 shows a sectional view taken along line 49-49 of FIG. 41 (clamping position);

FIGS. 50 to 60 show a fifth exemplary embodiment of a clamping apparatus in accordance with the invention, wherein:

FIG. 50 shows a side view of the clamping apparatus, shown as being in an unclamped state;

FIG. 51 shows a top view of the clamping apparatus of FIG. 50, when viewed in the direction A of FIG. 50;

FIG. 52 shows a top view of the clamping apparatus of FIG. 50, when viewed in the direction B of FIG. 51;

FIG. 53 shows the same view as FIG. 50, except in a clamping position;

FIG. 54 shows the same view as FIG. 51, except in a clamping position;

FIG. 55 shows the same view as FIG. 52, except in a clamping position;

FIG. 56 shows a sectional view taken along line 56-56 of FIG. 51 (unclamped position);

FIG. 57 shows a sectional view taken along line 57-57 of FIG. 54 (clamping position);

FIG. 58 shows a sectional view taken along line 58-58 of FIG. 50 (unclamped position);

FIG. 59 shows a sectional view taken along line 59-59 of FIG. 53 (clamping position);

FIG. 60 shows a sectional view taken along line 60-60 of FIG. 50;

FIGS. 61 to 65 show a first exemplary embodiment of a contact apparatus in accordance with the invention, wherein:

FIG. 61 shows a perspective view of the contact apparatus, shown as being in an unclamped state;

FIG. 62 shows a sectional view taken along line 62-62 of FIG. 61, except in an initial position;

FIG. 63 shows a sectional view taken along line 63-63 of FIG. 61, except in an initial position;

FIG. 64 shows the same view as FIG. 62, except in a clamping position;

FIG. 65 shows the same view as FIG. 63, except in a clamping position;

FIGS. 66 to 70 show a second exemplary embodiment of a contact apparatus in accordance with the invention, wherein:

FIG. 66 shows a perspective view of the contact apparatus;

FIG. 67 shows a sectional view taken along line 67-67 of FIG. 66, except in an initial position;

FIG. 68 shows a sectional view taken along line 68-68 of FIG. 66, except in an initial position;

FIG. 69 shows the same view as FIG. 67, except in a clamping position; and

FIG. 70 shows the same view as FIG. 68, except in a clamping position.

### DETAILED DESCRIPTION OF THE INVENTION

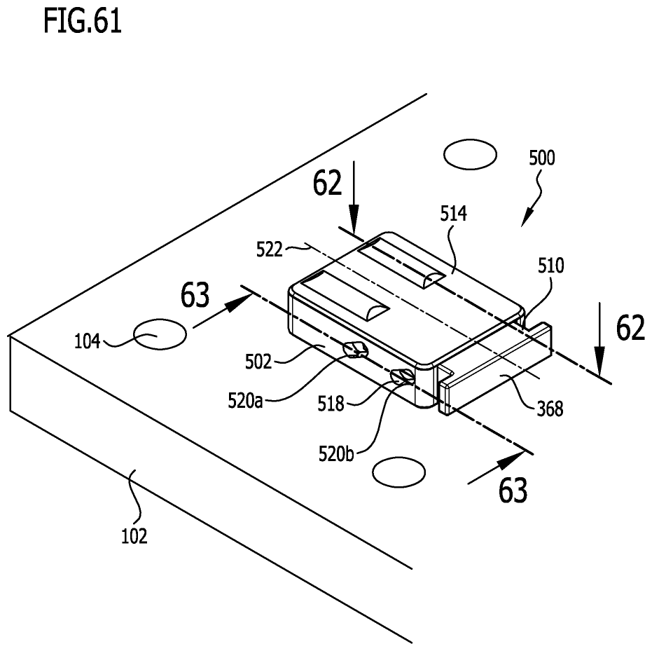

A clamping apparatus in accordance with the invention and a contact apparatus in accordance with the invention serve to clamp one or more workpieces against a plate 102 which is provided with openings 104 (cf. FIGS. 4 and 61). The plate 102 is, for example, a table top of a multifunction table (MFT). Having said this, a clamping apparatus in accordance with the invention or a contact apparatus in accordance with the invention can also be referred to as an MFT clamping apparatus or an MFT contact apparatus respectively.

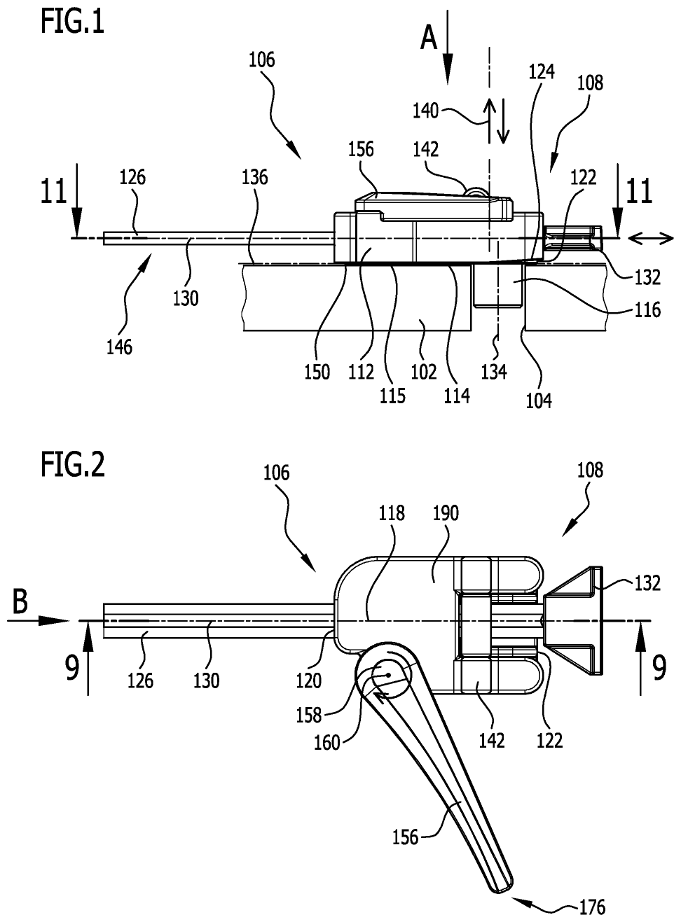

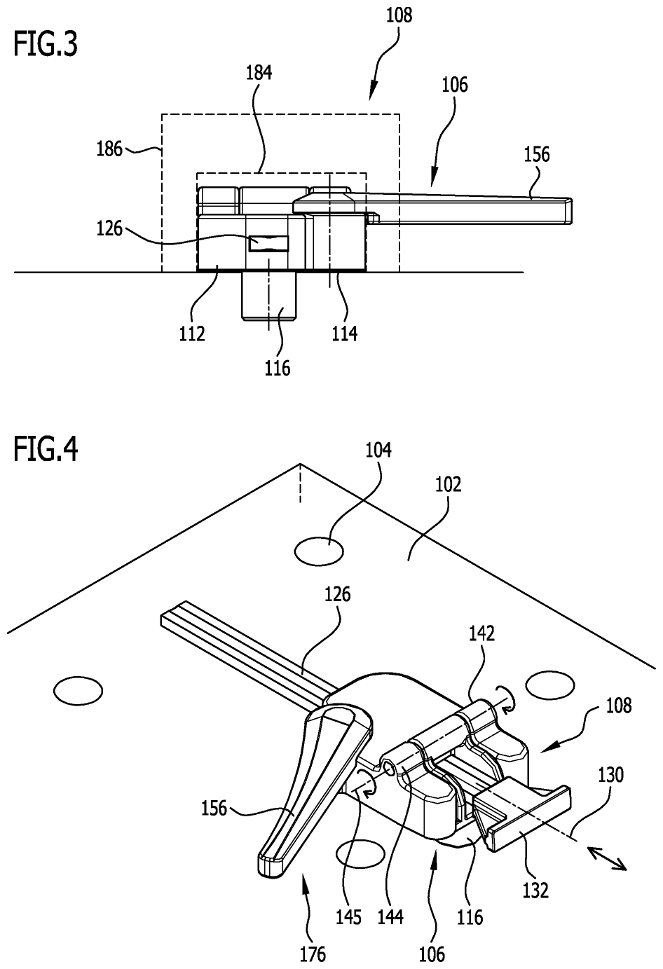

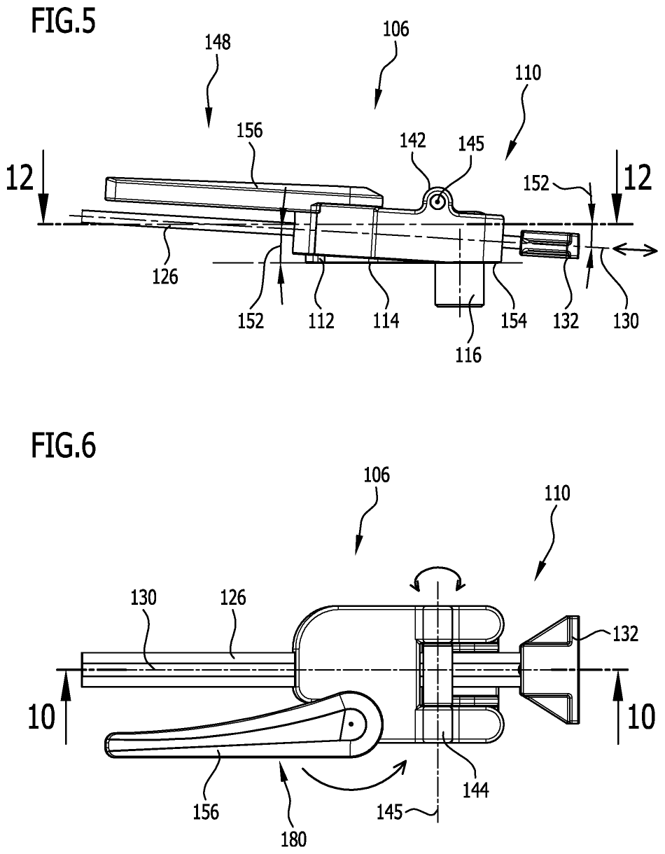

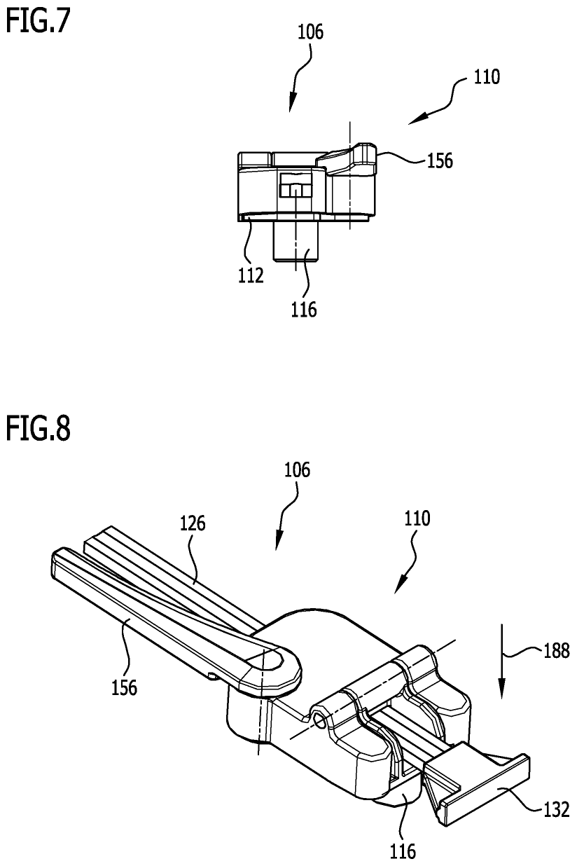

A first exemplary embodiment of a clamping apparatus 106 in accordance with the invention is shown in FIGS. 1 to 12, wherein shown in FIGS. 1, 2, 3, 4, 9, 11 is a non-clamping state 108 and shown in FIGS. 5, 6, 7, 8, 10, 12 is a clamping state 110. In the clamping state 110, which requires a clamped workpiece, the workpiece has been omitted (cf. FIG. 3).

The clamping apparatus 106 in accordance with the first exemplary embodiment comprises a holding body 112. The holding body 112 forms a base of the clamping apparatus 106. The holding body 112 has an underside 114. The underside 114 serves to make contact against the plate 102 (cf. FIG. 1). The underside 114 has or forms a contact surface 115 which is in particular planar.

Located at the holding body 112 is a bolt 116. The bolt 116 projects from the underside 114 of the holding body 112. The bolt 116 is provided for entering an opening 104 of the plate (cf. FIG. 1).

When the clamping apparatus 106 is arranged at the plate 102, then the bolt 116 is entered in the associated opening 104. The holding body 112 lies with its underside 114 in contact against an upper side of the plate 102.

In particular, the bolt 116 is arranged at the holding body 112 such that the underside 114 covers the opening 104 so that particularly on all sides of the underside 114 around the bolt 116 there is contact with the plate 102.

The holding body 112 has a first end 120 and a second end 122, relative to a longitudinal axis 118. The bolt 116 is in closer proximity to the second end 122 than to the first end 120. In particular, the bolt 116 is not located centrally between the first end 120 and the second end 122 at the holding body 112.

At a location between the bolt 116 and the second end 122, the underside 114 has a portion 124 that is oriented at an incline to the contact surface 115. Said portion 124 forms a free space that enables tilting.

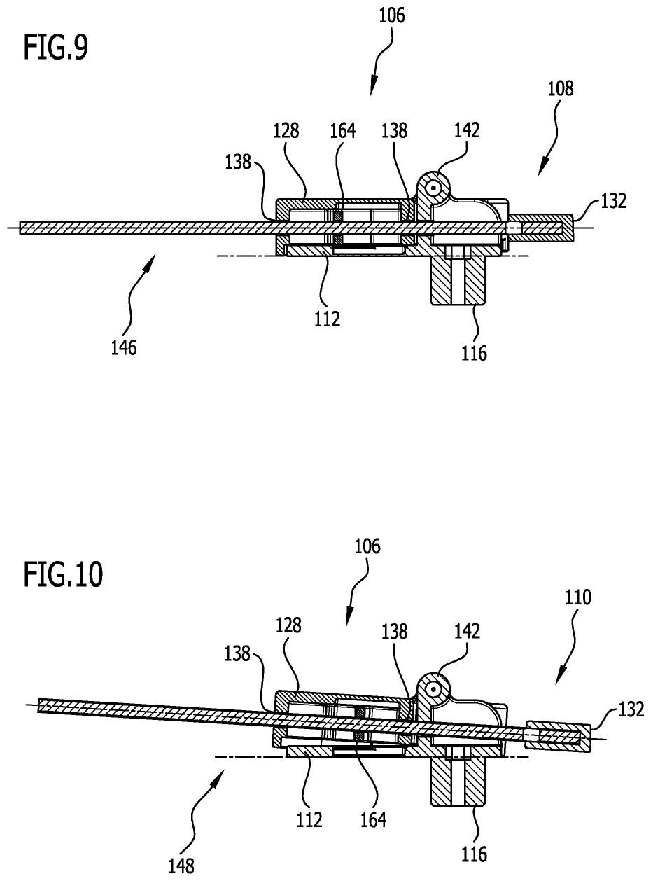

The clamping apparatus 106 comprises a clamping rail 126. The clamping rail 126 is guided for linear displacement on a guide element 128 (cf. FIGS. 9 to 12) in a displacement axis 130.

The clamping rail 126 has an adapted profile. This can be, for example, rectangular with rounded edges, circular or the like. Illustratively, reference is made to DE 10 2007 062 278.

The guide element 128 is located at the holding body 112 or is directly or indirectly connected thereto.

The clamping rail 126 is guided for sliding movement on the guide element 128; the clamping rail 126 is a sliding rail.

A pressure piece 132 is arranged in the area of one end of the clamping rail 126. The pressure piece acts upon a workpiece that is to be clamped and is a contact element of the clamping apparatus for the workpiece.

In an exemplary embodiment, the clamping rail 126 is made of a metallic material. The pressure piece 132 is made, in particular, of a plastic material and is slid onto the clamping rail 126 (cf. FIGS. 9 and 10, for example).

It is in principle also possible for the pressure piece to be formed directly on the clamping rail by corresponding shaping of the clamping rail 126 in the area of the corresponding end thereof.

The bolt 116 has a height axis 134. The height axis 134 of the bolt 116 is transverse and in particular perpendicular to the underside 114 of the holding body 112. The holding body 112 has a horizontal axis 136 associated therewith. The horizontal axis 136 is transverse and in particular perpendicular to the height axis 134 of the bolt 116. The contact surface 115 of the underside 114 of the holding body 112 is parallel to the horizontal axis 136.

The longitudinal axis 118 is parallel to the horizontal axis 136; the horizontal axis 136 extends between the first end 120 and the second end 122.

When the clamping apparatus 106 is properly positioned against the plate 102 with the bolt 116 entered in the associated opening 104, the horizontal axis 136 is parallel to the plate 102 if the plate 102 is planar.

The displacement axis 130 of the clamping rail 126 is transverse to the height axis 134. In the clamping apparatus 106, the angular position of the displacement axis 130 varies relative to the height axis 134; this will be discussed in further detail below.

The guide element 128 has openings 138, and in particular a plurality of spaced apart openings 138 (cf. FIGS. 9 and 10), through which the clamping rail 126 is passed and via which the clamping rail 126 is supported for slidable displacement on the guide element 128.

The guide element 128 is configured for height movement in a height direction 140, wherein the height direction 140 runs parallel to the height axis 134 of the bolt 116 (and hence also parallel to an axis of an opening 104 of the plate 102 when the clamping apparatus 106 is properly used).

Such height mobility affords the possibility of varying a distance of the pressure piece 132 to the bolt 116 and to the holding body 112 (cf. FIGS. 10 and 9). Correspondingly, the distance of the pressure piece 132 to the plate 102 can thereby be varied, as will be discussed in further detail below. The height distance is parallel to the height axis 134 of the bolt 116. Correspondingly, the height distance is also parallel to a normal of the plate 102 if the plate 102 is planar.

In the clamping apparatus 106, the height mobility of the guide element 128 is implemented via a pivot bearing 142 by way of which the guide element 128 is supported on the holding body 112. Via the pivot bearing 142, the guide element 128 which provides guidance to the clamping rail 126 is configured as a rocker.

The pivot bearing 142 is connected to the holding body 112 and is spaced apart from the holding body 112 in the height direction 140; the pivot bearing 142 is located at a bridge 144 and is positioned above the holding body 112.

The clamping rail 126 is positioned between the pivot bearing 142 and the holding body 112, relative to the height direction 140.

A projection of the pivot bearing 142 in the height direction 140 lies on the bolt 116 or at a distance of no more than 2 cm to the bolt 116. Additional tilting moments can thereby be obviated.

A pivot axis 145 of the pivot bearing 142 about which the guide element 128 is pivotable relative to the holding body 112, and thereby also relative to the bolt 116, is oriented transversely and in particular perpendicularly to the displacement axis 130 of the clamping rail 126. Furthermore, the pivot axis 145 is oriented transversely and in particular perpendicularly to the height axis 134 or the height direction 140.

In particular, the pivot axis 145 is oriented at least approximately parallel to the underside 114 or to the contact surface 115 of the holding body 112.

The guide element 128, with respect to its pivotability on the pivot bearing 142, has two marked positions, namely a first position 146 (FIGS. 1 to 4, 9, 11) and a second position 148 (FIGS. 5 to 8, 10, 12).

In the first position 146, the guide element 128, at a rear area of an underside 150 thereof, is in contact against the holding body 112. The pivotability of the guide element 128 towards the holding body 112 is limited by contact (stopping) against the holding body 112. In the first position 146, the displacement axis 130 of the clamping rail 126 for the displaceability of the clamping rail 126 on the guide element 128 is parallel to the contact surface 115 of the holding body 112 against the plate 102. Furthermore, the clamping rail 126 is oriented such that its displacement axis 130 is perpendicular to the height axis 134 of the bolt 116.

In the first position 146 of the guide element 128 (which is a first pivot position), the clamping rail 126 is freely displaceable on the guide element, as will be explained in more detail below.

In the first position 146, the displacement axis 130 is oriented parallel to the horizontal axis 136.

In the second position 148, which is a second pivot position, the guide element 128 is tilted on the pivot bearing 142 relative to the holding body 112 (cf. FIG. 5). The clamping rail 126 lies with its displacement axis 130 at an acute angle 152 (cf. FIG. 5) with respect to the horizontal axis 136. Correspondingly, the same acute angle 152 also exists between the displacement axis 130 and the contact surface 115. In the case of a planar plate 102, the displacement axis 130 lies also at the acute angle relative to the plate 102.

The acute angle 152 is less than 10°, and is in particular less than 7° and in particular less than 5°. In a concrete embodiment, the angle is about 4.5°.

Here, the clamping apparatus 106 is dimensioned such that the acute angle 152 is sufficiently “small” that the clamping rail 126 will not project beyond the underside 114 of the holding body 112 in any position of the clamping rail 126 relative to the guide element 128, with respect to the displacement axis 130. This prevents the clamping rail 126 from striking against the plate 102 when it is displaced.

The second position 148 is defined by a front region 154 of the guide element 128 being in contact against the holding body 112, thereby causing further pivotal movement to be blocked.

In principle, the guide element 128 is pivotable between the first position 146 and the second position 148, wherein, the angular position of the clamping rail 126, with the displacement axis 130 thereof in the second position 148, has a maximum angular position (at the acute angle 152) relative to the horizontal axis 136 or the contact surface 115.

A clamping lever 156 is rotatably (pivotably) arranged at the guide element 128. The clamping lever 156 is provided for engagement by an operator (and in particular hand engagement), wherein the operator can then apply the necessary clamping force for clamping one or more workpieces against the plate 102 via the clamping lever 156.

In the clamping apparatus 106, the clamping lever 156 is rotatably arranged at the guide element 128 and is thereby also pivotable with the guide element 128 about the pivot axis 145.

The clamping lever 156 is located at the guide element 128 via a pivot bearing 158. A pivot axis 160 of the pivot bearing 158 is transversely oriented. In the first position 146 of the guide element 128, the pivot axis 160 is oriented perpendicularly to the horizontal axis 136 and perpendicularly to the contact surface 115. It is oriented parallel to the height axis 134 of the bolt.

When the plate 102 is planar and the clamping apparatus 106 is correctly contacted thereagainst, the pivot axis 160 is oriented transversely to the plate 102.

By the mobility of the clamping lever 156 with the pivoting of the guide element 128 about the pivot bearing 142, the pivot axis 160 in the second position 148 is oriented at an acute angle (corresponding in magnitude to the acute angle 152) relative to the height axis 134.

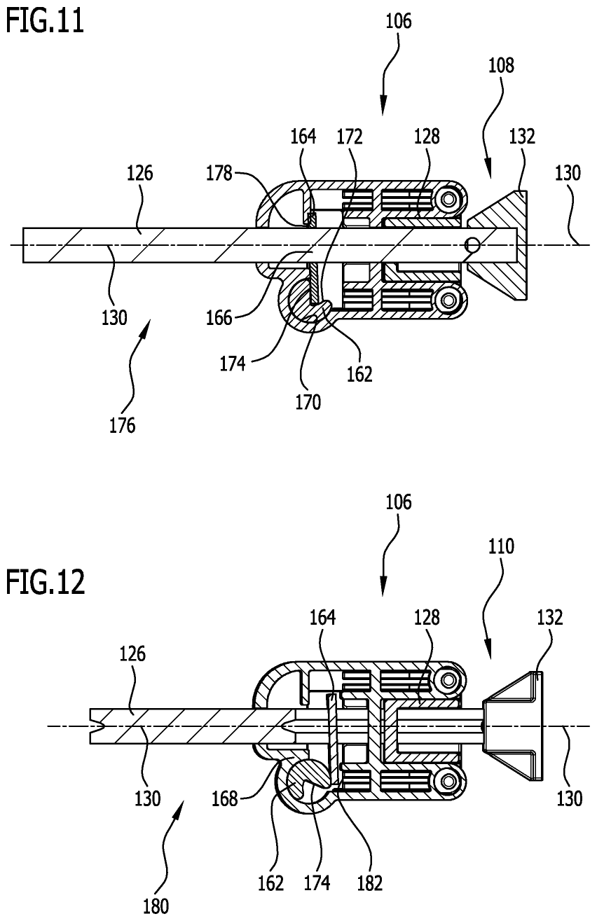

An operative element 162 is connected in rotationally fixed relation to the clamping lever 156 (cf. FIGS. 11 and 12). The operative element 162 is formed as an eccentric element.

At least one advance element 164 is located at the guide element 128. In the illustrated exemplary embodiment of the clamping apparatus 106, one single advance element 164 is shown. In particular, provision is made for a plurality of advance elements, such as two or three advance elements, to be used as an advance element package.

The clamping rail 126 is arranged at the at least one advance element 164. The corresponding advance element 164 has an opening 166 through which the clamping rail 126 is passed.

The at least one advance element 164 is formed as a plate (small plate) and is, in particular, made of a metallic sheet material.

The at least one advance element 164 is arranged and formed such that, in a certain position (as will be explained in more detail below), the clamping rail 126 is freely movable, and in particular displaceable, through the opening 166 of the at least one advance element 164. It is further possible, by actuation of the clamping lever 156, for the advance element 164 to be canted relative to the clamping rail 126 and for the clamping rail to then be displaced via the at least one advance element 164 in order to achieve a clamping position.

In an embodiment, the operative element 162 is formed of a cylindrical shape having a cylindrical outer contour 168. The operative element 162 is supported on a hollow cylindrical receptacle 170 of the guide element 128. The receptacle 170 forms a pivot bearing (rotary bearing) for the operative element 162, and in particular a sliding bearing.

The operative element 162, with its cylindrical outer shape, has a cutout 172. This cutout 172 has a cross-sectional form of that of a segment of a circle (cf. FIGS. 11, 12). When the at least one advance element 164 lies in the cutout 172 (FIG. 11), then, via the eccentric configuration of the operative element 162, a canting of the at least one advance element 164 relative to the clamping rail 126 can be achieved and advancement can be effected. In particular, the at least one advance element 164 can be brought out of the cutout 172 and against the outer contour 168 in order to achieve a blocked clamping position (FIG. 12).

The cutout 172 is bounded by a wall 174, and is bounded by a planar wall 174 in particular (FIGS. 11, 12).

The clamping lever 156 has a first position 176 (first pivot position 176). This is shown in FIGS. 1 to 4, 9, 11.

In the first position 176 of the clamping lever 156, the operative element 162 is positioned such that its wall 174 is perpendicular to the displacement axis of the clamping rail 126 (FIG. 11).

Arranged at the guide element 128 is a counter element 178 of the operative element 162. The counter element 178 is arranged opposite the operative element 162, wherein the clamping rail lies between the operative element 162 and the counter element 178 (FIG. 11). The counter element 178 is a contact element for the at least one advance element 164.

In the first position 176, the at least one advance element 164 is oriented perpendicularly with respect to the clamping rail 126 including the displacement axis 130 (FIG. 11). The at least one advance element 164 is in contact against the counter element 178 and the wall 174 of the operative element 162. The displaceability of the clamping rail 126 is thereby released, and the clamping rail is permitted free displacement relative to the guide element 128. For example, an operator can grasp the clamping rail 126 by the pressure piece 132 and freely displace the clamping rail 126 in the forward direction (with the pressure piece 132 receding from the holding body 112) or in the backward direction, opposing the forward direction, until a corresponding stop is encountered or the clamping rail is pulled out.

In an exemplary embodiment, the clamping rail 126 is provided with a stop element that prevents complete pullout of the clamping rail 126 from the guide element 128 in the forward direction. In the backward direction, complete pullout is prevented by the pressure piece 132 striking the guiding element 128 or the holding body 112.

When the clamping lever 156 is pivoted starting from the first position 176, the operative element 162 will rotate. Such rotation first causes a pivotal movement of the operative element 162, which is still in contact against the counter element 178. This pivoting of the at least one advance element 164 relative to the clamping rail 126 effects canting.

Further pivoting of the clamping lever 156 out of the first position 176, because of the eccentric configuration of the operative element 162 (cf. FIG. 12), causes advancement of the at least one advance element 164 on the guide element 128. This leads to a forward movement of the clamping rail 126 in the displacement axis 130 (cf. FIG. 12).

The clamping lever has a second position 180 (second pivot position); this is shown in FIGS. 5 to 8 and 10, 12.

The second position 180 is a maximum position and corresponds to a clamping state 110 of the clamping apparatus 106.

In the second position 180 of the clamping lever 156, the at least one advance element 164 has been brought out of the cutout 172 and is in contact against the outer contour 168 (FIG. 12). A dead center point is thereby reached, and the second position 180 is blocked. A considerably larger exertion of force is required for unblocking the second position 180, i.e., for returning to the first position 176. The second position 180, and hence the clamping state 110 of the clamping apparatus 106, can thereby be secured. A self-locking capability is provided in order to block the second position 180. The self-locking capability is achieved by reaching a dead center position (a “potential valley”) as a result of the transition from being in contact against the cutout 172 (against the wall 174) to being in contact against the outer contour 168.

In particular, it is provided that, at the guide element 128, a contact 182 is formed for the at least one advance element 164 in the second position 180 of the clamping lever 156.

The clamping of a workpiece against the plate 102 via the clamping apparatus 106 works as follows:

A contact apparatus 184 as a counter element to the clamping apparatus 106 is located at the plate (cf. FIG. 3). As an example, the contact apparatus can have a configuration similar to that of the clamping apparatus with holding body and bolt or it can also be a wall which is fixedly connected to the plate, and is, for example, secured thereto by screws.

A workpiece 186 is arranged at the contact apparatus 184. In the first position 176 of the clamping lever 156, the pressure piece 132 is brought against the workpiece 186 by an operator. Starting from the first position 176, the operator then pivots the clamping lever 156 into the second position 180. Then, as has been described previously, in this pivoting movement of the clamping lever 156, the at least one advance element 164 is first canted and then displaced. Thereby, the clamping rail 126, via the canted at least one advance element 164, is displaced along therewith and the required clamping force is exerted. In the second position 180, the corresponding clamping state 110 is attained and the workpiece is clamped against the plate 102, between the contact apparatus 184 and the clamping apparatus 106.

Via the configuration of the guide element 128 as a rocker which is pivotable on the pivot bearing 142 about the pivot axis 145, a height mobility of the pressure piece 132 exists in the height direction 140, relative to the holding body 112 and the bolt 116. Here, a height distance in the height direction 140 is variable between the pressure piece 132 and the holding body 112 and the bolt 116.

When a workpiece 186 is clamped, then, by the height mobility of this pressure piece 132 in the clamping operation, the guide element 128 can correspondingly move with the pressure piece 132 and yield in a downward direction. This then results in a hold-down force 188 (FIG. 8) which acts in the direction of the plate 102 and urges the holding body 112 against the plate 102 and urges the bolt 116 into the associated opening 104.

The height movement of the pressure piece 132 in a downward direction towards the holding body 112 (the plate 102) occurs when the workpiece is clamped. The pivotability of the guide element 128 on the pivot bearing 142 enables the pressure piece 132 (which is in contact against the workpiece 186) to move towards the plate 102, which in turn creates the hold-down force 188.

This provides a way of preventing the workpiece from being pushed up or, at the extreme, even lifted off the plate 102.

Simplicity of operation is provided for an operator.

In FIGS. 5 to 8, 10, 12, the clamping state 110 is shown where the position of the maximum acute angle 152 exists. This position is generally only reached when the pressure piece 132 makes contact against a workpiece, although such workpiece is not drawn in the figures mentioned. Furthermore, the maximum acute angle 152 does not necessarily have to be reached in the clamping state 110 when the clamping lever 156 is in the second position 180. An angle smaller than the acute angle 152 can also be reached.

The clamping apparatus 106 has a housing 190, which in particular is arranged at the guide element 128. The housing 190 is pivotable together with the guide element 128 (and, hence, a height mobility of the pressure piece 132 is achieved). The housing 190 is closed towards the outside. In particular, the operative element 162 and the at least one advance element 164 are arranged and thereby protected in the housing 190.

When the at least one advance element 164 is canted relative to the clamping rail 126 and the clamping lever 156 is outside its first position 176, a backward movement of the clamping rail 126 towards the holding body 112 is blocked. Forward movement of the pressure piece 132 away from the holding body 112 is still possible and can be actuated by actuating the clamping lever 156 in a direction towards the second position 180.

A (first) spring device can be provided which ensures that the guide element 128 is urged into its first position 146 such that, in order for it to move out of the first position 146, the corresponding spring force must be overcome.

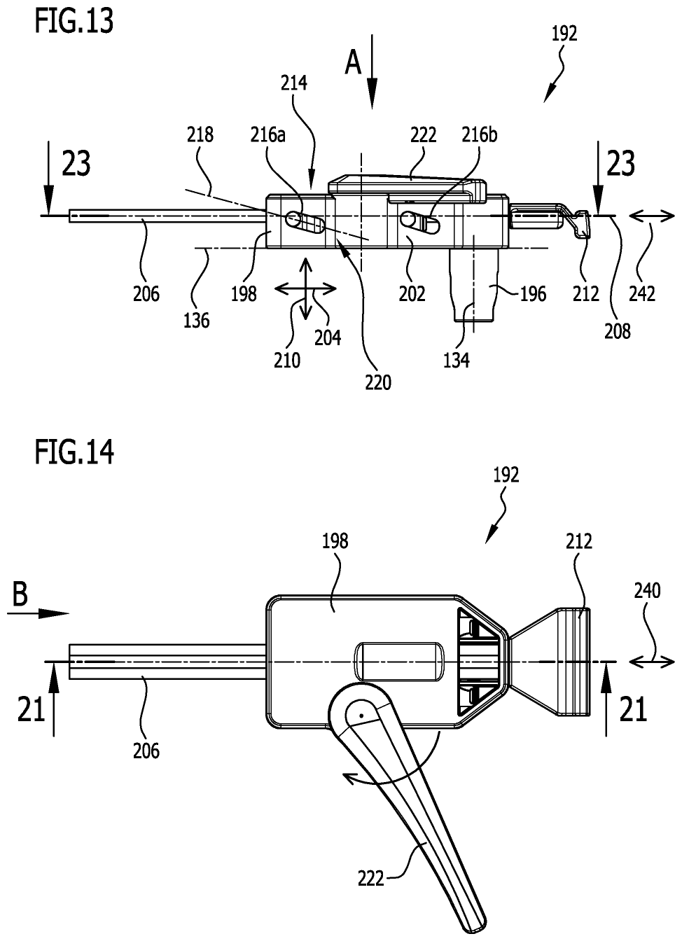

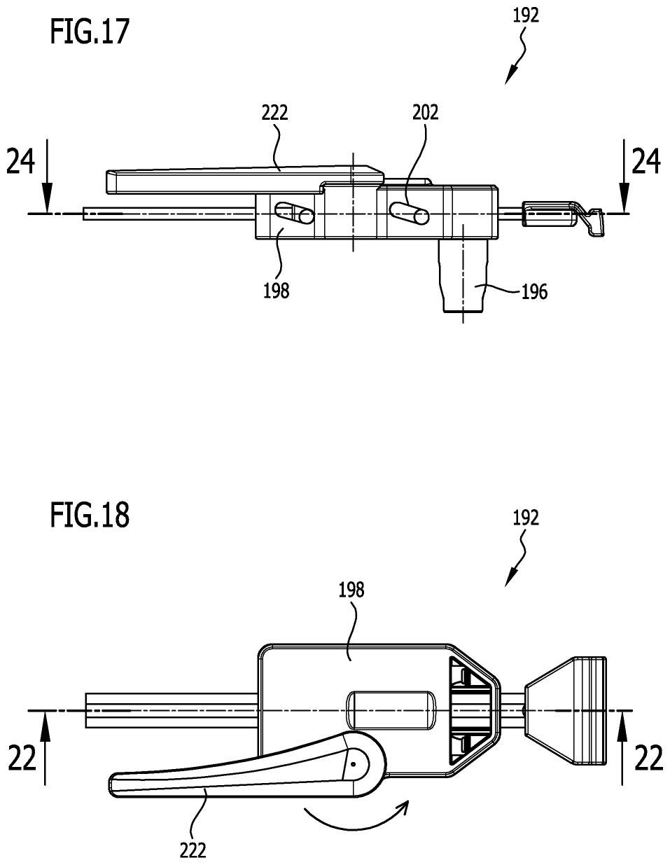

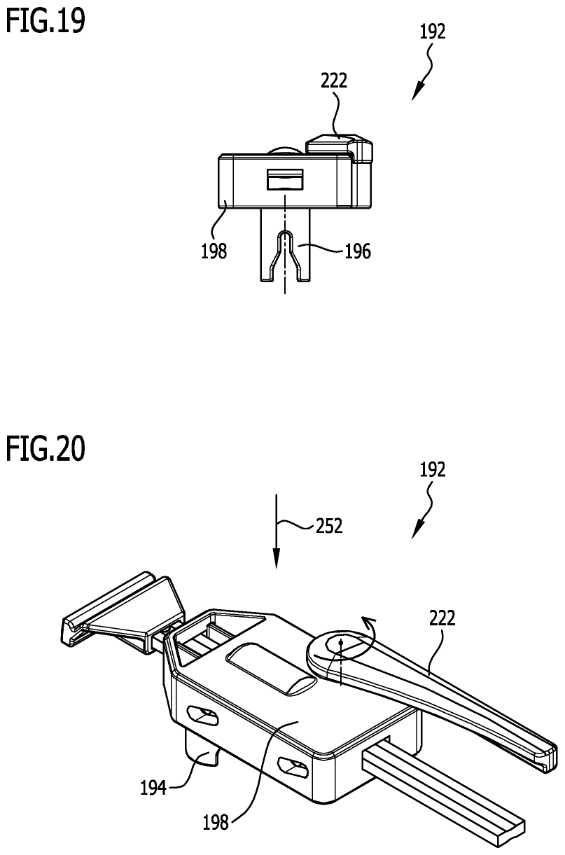

A second exemplary embodiment of a clamping apparatus in accordance with the invention is shown in FIGS. 13 to 24 and designated 192 therein. Here, in FIGS. 13 to 16, 21, 23, a non-clamping state corresponding to the non-clamping state 108 is shown. FIGS. 17 to 20, 22, 24 show a clamping state corresponding to the clamping state 110.

The clamping apparatus 192 comprises a holding body 194 at which is located a bolt 196. Generally, the holding body 194 and the holding body 112 are functionally identical. The holding body 194 has an underside 114 in contact against the plate 102. The bolt 196 is provided for entering the corresponding opening 104 of the plate 102.

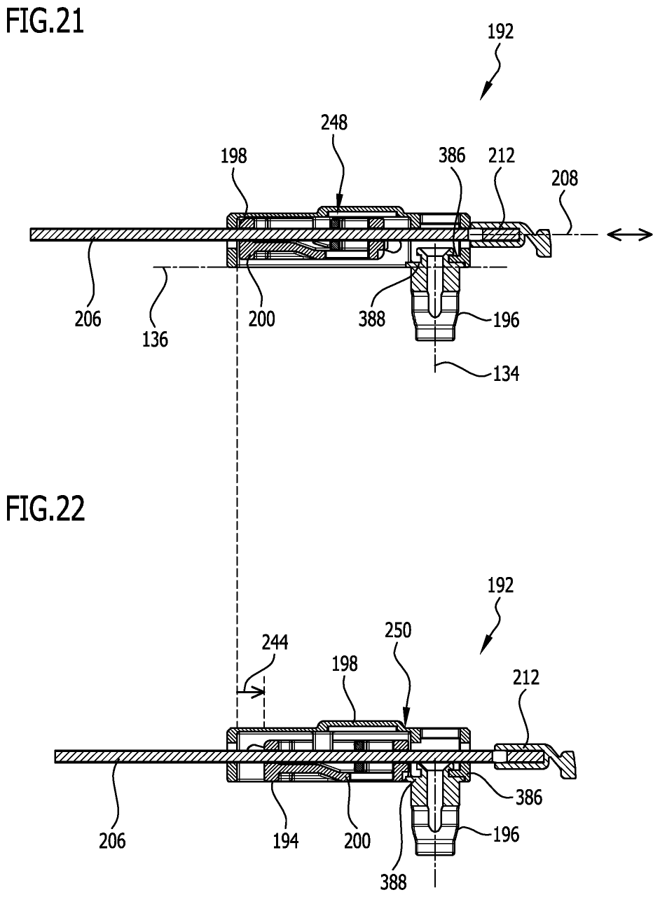

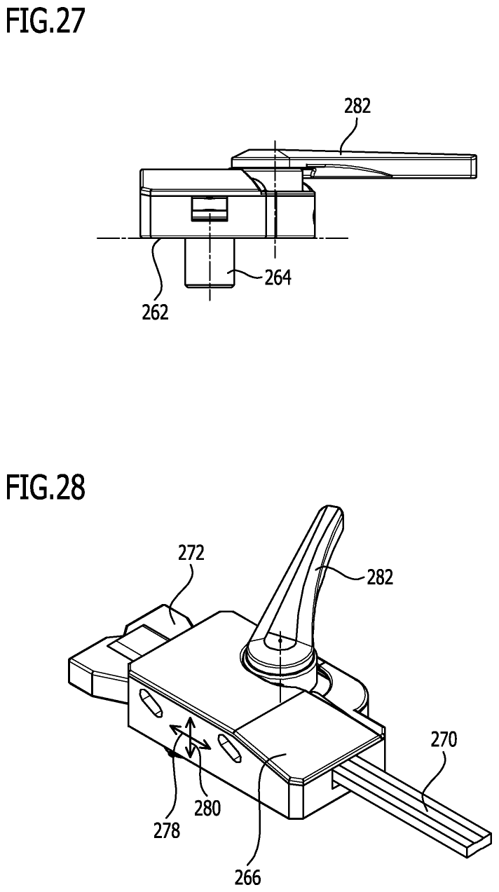

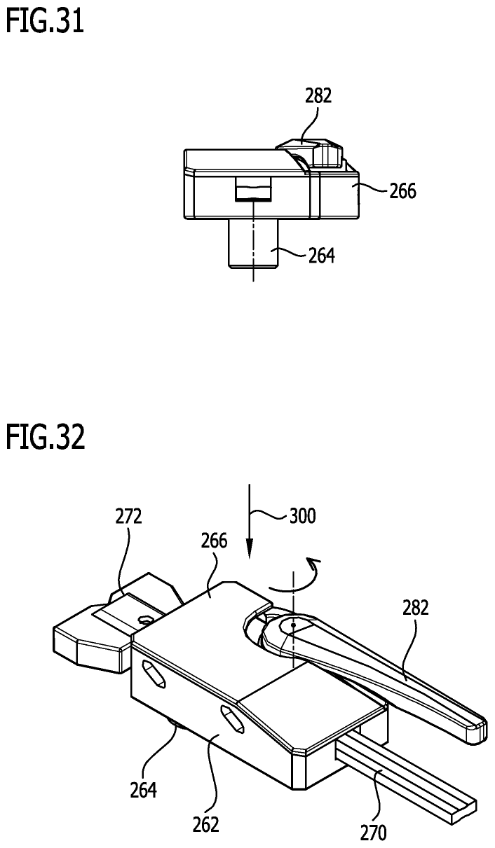

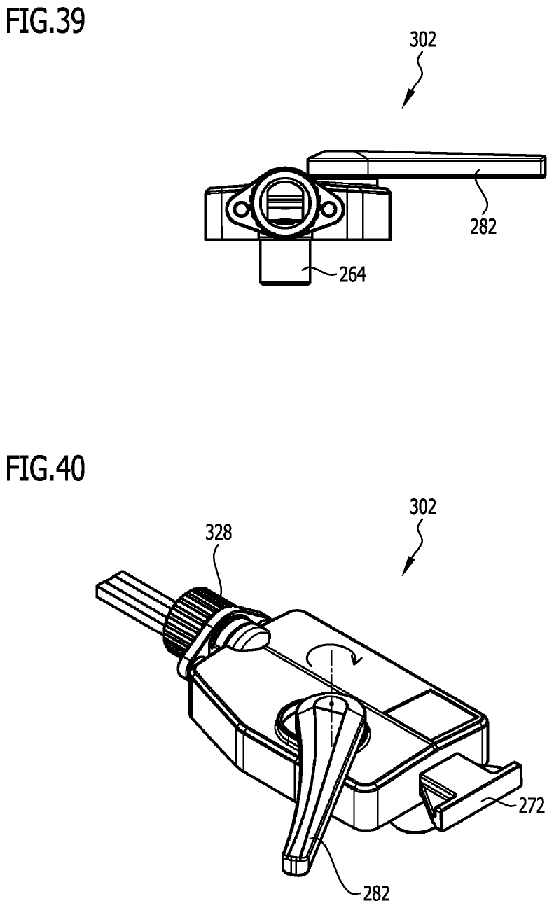

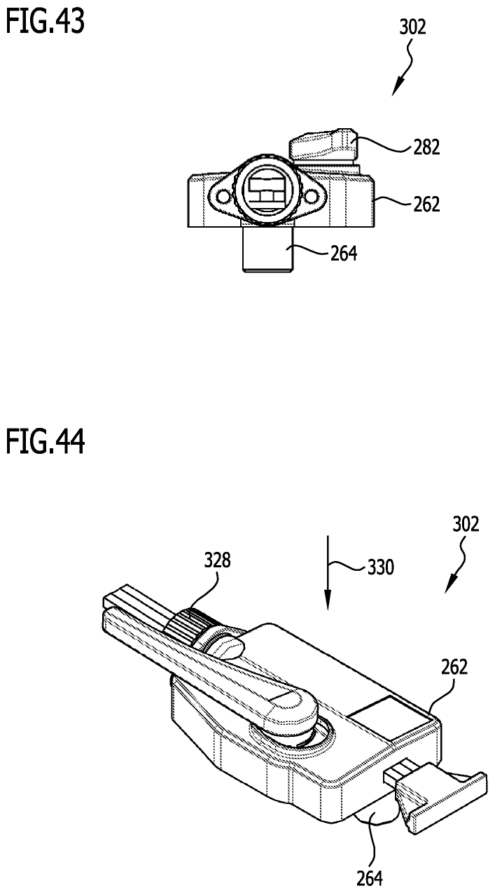

Located at the holding body 194 is a housing 198 or the housing 198 is part of the holding body 194. A guide element 200 is displaceably arranged in the housing 198 (FIGS. 21 to 44). The guide element 200 is supported for displacement on a displacement bearing 202.

The displacement bearing 202 enables the guide element 200 to be displaced as a whole in a direction/counter direction 204 (FIG. 13). A clamping rail 206 is displaceably supported on the guide element 202. The clamping rail is supported for displacement in a displacement axis 208. The displacement axis 208 is parallel to a horizontal axis 136 (the same reference characters are used for elements that are also present in the clamping apparatus 106). The horizontal axis 136 is parallel to a contact surface of the holding body 194 against the plate 102. The direction/counter direction 204 of the linear displaceability of the guide element 200 on the displacement bearing 202 is parallel to the displacement axis 208 (and hence parallel to the horizontal axis 136). It is then correspondingly transverse and in particular perpendicular to a height axis 134 of the bolt 196.

Furthermore, by virtue of the displacement bearing 202, the guide element 200 is given height displaceability in a direction/counter direction 210 (FIG. 13) which is perpendicular to the direction/counter direction 204.

Correspondingly, the guide element 200 and hence the clamping rail 206 is then displaceable in the direction/counter direction 210, wherein the direction/counter direction 210 is a height direction. The height direction is parallel to the height axis 134 of the bolt 196.

A pressure piece 212 is arranged at the clamping rail 206. By virtue of the configuration of the displacement bearing 202 with a displaceability of the guide element 200 in the direction/counter direction 210, a height distance of the pressure piece 212 to the holding body 194 and to the bolt 196 can be varied.

The clamping rail 206 is first guided for displacement on the guide element 200. The guide element 200 itself is configured in the form of a slide and is guided, via the displacement bearing 202, relative to the holding body 194, in the direction/counter direction 204 and in the direction/counter direction 210 and, here, in particular on the housing 198.

In an exemplary embodiment, the displacement bearing 202 is formed via an elongated hole guide 214. Said elongated hole guide 214 in a first exemplary embodiment comprises a pair of first elongated holes 216a and a pair of second elongated holes 216b, said pairs being spaced apart in a direction parallel to the displacement axis 208 of the clamping rail 206. The clamping rail 206 is positioned between the elongated holes of a respective pair.

In an exemplary embodiment, the first elongate hole 216a and the second elongated hole 216b are arranged at the housing 198. The elongated holes of each pair are arranged at the housing on opposing sides of the housing.

The first elongated hole 216a and the second elongated hole 216b are oriented at an oblique angle with respect to the horizontal axis 136. They each have a longitudinal axis 218 at (equal) acute angles 220 with respect to the horizontal axis 136.

The acute angle is in the range between 10° and 30°. In a concrete exemplary embodiment, the angle is about 20°.

In the clamping apparatus 192, the first elongated hole 216a and the second elongated hole 216b have identical configurations. They are arranged parallel to one another at the same height relative to the underside of the holding body 194.

Located at the guide element 200 are pins which are entered in the associated elongated holes.

The effect can thereby be achieved that in every position of the guide element, the clamping rail 206 lies with its displacement axis parallel to the horizontal axis 136.

A clamping lever 222 is located at the holding body 194. The clamping lever 222 is translationally fixed with respect to the holding body. The clamping lever 222 is not movable with the holding body 194.

The clamping lever 222 is pivotably located on a pivot bearing 224. A pivot axis 226 (cf. FIG. 16) is stationary with respect to the holding body 194 and parallel to the height axis 134 and perpendicular to the horizontal axis 136. The pivot axis 226 is oriented perpendicularly with respect to the displacement axis 208 of the clamping rail 206.

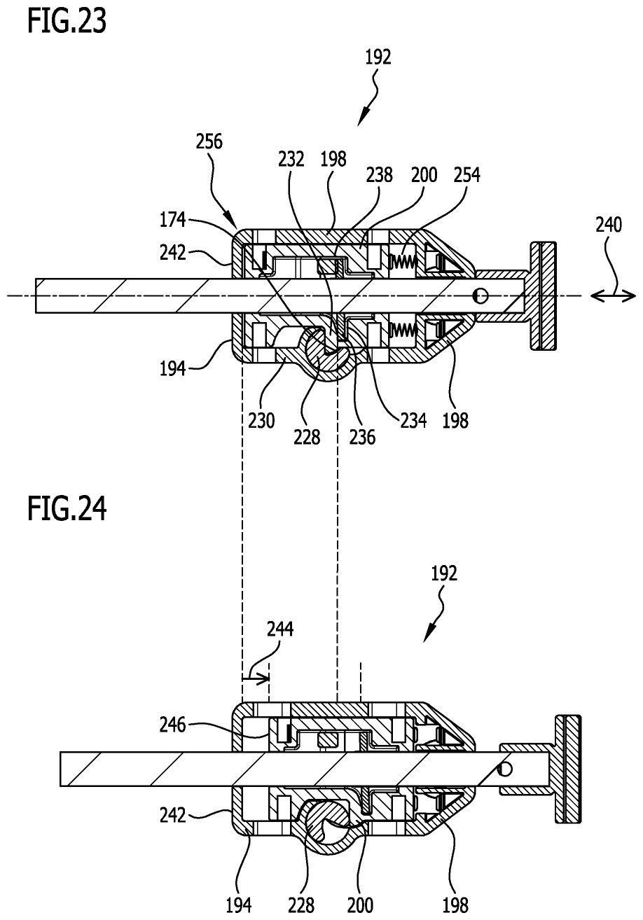

An operative element 228 is connected to the clamping lever 222 in rotationally fixed relation therewith (FIGS. 23, 24).

The operative element 228 is rotatably arranged on the housing 198 or the holding body 194 via the rotary bearing 230, and in particular sliding bearing 230. The operative element 228 is configured generally in the same manner as the operative element 162, having a corresponding cylindrical outer contour (corresponding to the outer contour 168) and cutout 172.

The operative element 228 acts directly on the guide element 200 which is configured in the form of a slide.

In a first position of the clamping lever (FIGS. 13 to 16, 21, 23), a wall 232 of the guide element 200 is in contact against a wall corresponding to the wall 174 of the operative element 288. (Therefore, the reference numeral 174 is used to refer to this wall of the operative element 228.)

A recess 234 is formed at the guide element 200, at a location opposite the wall 232 of the guide element 200. An advance element 236 is located in said recess. The advance element 236 corresponds to the advance element 164. A plurality of advance elements 236, and in particular an advance element package, can be provided.

Located on the opposite side is a counter element 238 formed at the guide element 200. The clamping rail 206 is arranged between the counter element 238 and the recess 234.

The first position of the clamping lever 222 corresponds to the first position 176 in the case of the clamping apparatus 106. The advance element 236 is in contact against the wall 232 and against the counter element 238, and the clamping rail 206 is passed through an opening of the advance element 236 and, here, is freely movable. The clamping rail 206 is freely displaceable along the displacement axis 208, relative to the guide element 200, in a forward direction/backward direction 240 (FIG. 23).

The operative element 228 acts directly on the wall 232 of the guide element 200. The guide element 200 in turn acts upon the advance element 236 in the recess 234.

When the clamping lever 222 is pivoted into a second position (corresponding to the second position 180 in the case of the clamping apparatus 106), wherein this second position is shown in FIGS. 17 to 20, 22, 24, at the commencement of the pivoting movement out of the first position, the eccentric operative element 228 acts on the guide element 200 and displaces the latter away from a rear end 242 of the holding body 194 (FIGS. 23, 24).

A displacement direction is parallel to the displacement axis 208 of the clamping rail 206.

A distance 244 between a rear end 246 of the guide element 200 and the rear end 242 of the holding body 194 is thereby increased.

The rear end 246 of the guide element slide faces towards the rear end 242 of the holding body 194.

The rear end 242 of the holding body 194 can also be regarded as a rear end of the housing 198.

Starting from the first position, rotation of the eccentric operative element 228, via the forward displacement of the guide element 200, causes the advance element 236 to cant relative to the clamping rail 206. Further rotation of the operative element 228, which causes the displacement of the guide element 200, then also acts on the advance element 236 in the recess 234. The canted advance element 236 is co-moved along with the guide element slide 200 and causes displacement of the clamping rail 206 along the axis of displacement 208 in the forward direction, wherein a distance of the pressure piece 212 to the holding body 194 or to the housing 198 is increased.

Again, in the second position of the clamping lever, a return movement is blocked by a self-locking mechanism, as has been described previously with reference to the operative element 162 in the case of the clamping apparatus 106.

FIG. 24 shows a position of the guide element 200 when the clamping lever 222 is in its second position.

The distance 244 exists between the rear end 246 and the rear end 242 of the holding body 194.

The forward displacement of the guide element 200 also means a lowering in the height direction parallel to the height axis 134 (cf. FIGS. 21 and 22).

Starting from an upper position 248 (FIG. 21), the guide element 200, in its forward displacement, moves to a lower position 250 (FIG. 22) via the displacement bearing 202.

In the lower position 250, the pressure piece 212 is in closer proximity to the underside of the holding body 194 or in closer proximity to the bolt 196.

A hold-down force 252 is thereby created in the clamping operation (cf. FIG. 20).

In an exemplary embodiment, a first spring device 254 (FIG. 23) is provided via which the guide element 200 is supported on the holding body 194 or the housing 198 in a direction that faces away from the rear end 242 of the holding body 194.

The first spring device 254 is configured such that it holds the guide element 200 in a first position 256 (FIG. 23). The first position 256 exists when the clamping lever 222 is in the first position. When the guide element 200 is in the first position 256, the upper position 248 (FIG. 21) of the guide element 200 exists.

The first spring device 254 provides for the guide element 200 to be in the first position 256 with no actuation of the clamping lever 222 and provides for the guide element 200 to go to the first position 256 when the clamping lever 222 is moved out of the second position.

In order to move the guide element 200 out of the first position 256, the spring force of the first spring device 254 must be overcome. This is accomplished by an operator actuating the clamping lever 222 and pivoting the clamping lever 222 out of its first position.

In the first position of the clamping lever 222, the clamping rail 206 is freely displaceable on the guide element 200 in both the forward and the backward direction. When the clamping lever 222 is pivoted out of the first position (and, thereby, the guide element 200 is also displaced out of an upper position 248 thereof), the operative element 228 is canted, and only a displacement of the clamping rail 206 in the forward direction is then possible, wherein, by the displacement in the forward direction, the distance of the pressure piece 212 to the holding body 194 or to the housing 198 is increased. A displacement in the backward direction is blocked for the clamping rail 206.

The clamping apparatus 192 works as follows:

The clamping apparatus 192 is correspondingly fixed against the plate 102, wherein the bolt 196 is entered into the associated opening 104.

A corresponding contact apparatus is provided as a counter element.

In the first position of the clamping lever 222, the clamping rail 206 is displaced until the pressure piece 212 is in contact against the corresponding workpiece that is to be clamped or until the pressure piece 212 is located just ahead of the workpiece.

In the first position of the clamping lever 222, the guide element (the guide element slide 200) is in the upper position 248. The distance of the guide element 200 from the rear end 246 thereof to the rear end 242 of the holding body 194 is minimal.

The clamping lever 222 is pivoted out of the first position. The guide element 200 is then displaced forwards (away from the rear end 242 of the holding body 194) by direct contact with the eccentric operative element 228 (cf. FIGS. 21 and 22 and FIGS. 23 and 24).

The operative element 228 is then first canted and displaced relative to the clamping rail 206. The clamping rail 206 is thereby displaced forward and the corresponding clamping force is applied.

As the guide element 200 is displaced forwards (away from the rear end 242 of the holding body 194), the guide element 200 is also displaced downwardly in a direction towards the holding body 194 and the bolt 196. By such displacement, the clamping rail 206 is carried along therewith and also displaced downward in a direction towards the holding body 194 and the bolt 196. This in turn causes the distance of the pressure piece 212 to the holding body 194 and to the bolt 116 to be reduced. It also causes the distance of the pressure piece 212 to the plate 102 to be reduced.

A hold-down force 252 is thereby exerted on the clamping apparatus 192 in the direction of the plate 102.

In particular, when the clamping lever 222 has reached the second position (FIGS. 22, 24), the lower position 250 of the guide element 200, relative to the height displaceability, has been reached. In the second position, a pivoting movement of the clamping lever 222 is blocked. A corresponding force must be overcome in order for the clamping lever 222 to be moved out of its second position.

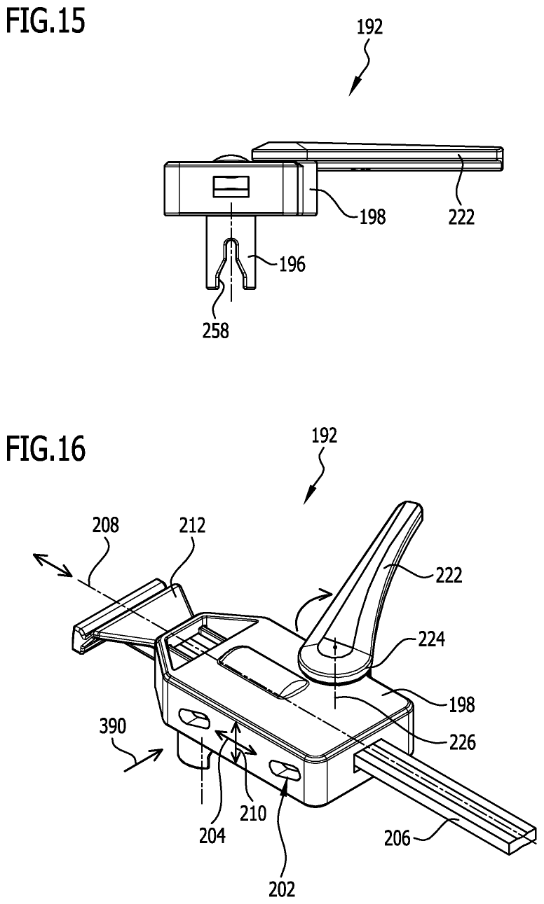

In the exemplary embodiment of the clamping apparatus 192, a bolt 196 is shown which has a non-solid configuration and has a cutout 258 (cf. FIG. 15).

It is also possible for the bolt 196 to be of solid configuration or for the bolt 116 of the clamping apparatus 106 to also have a corresponding cutout 258.

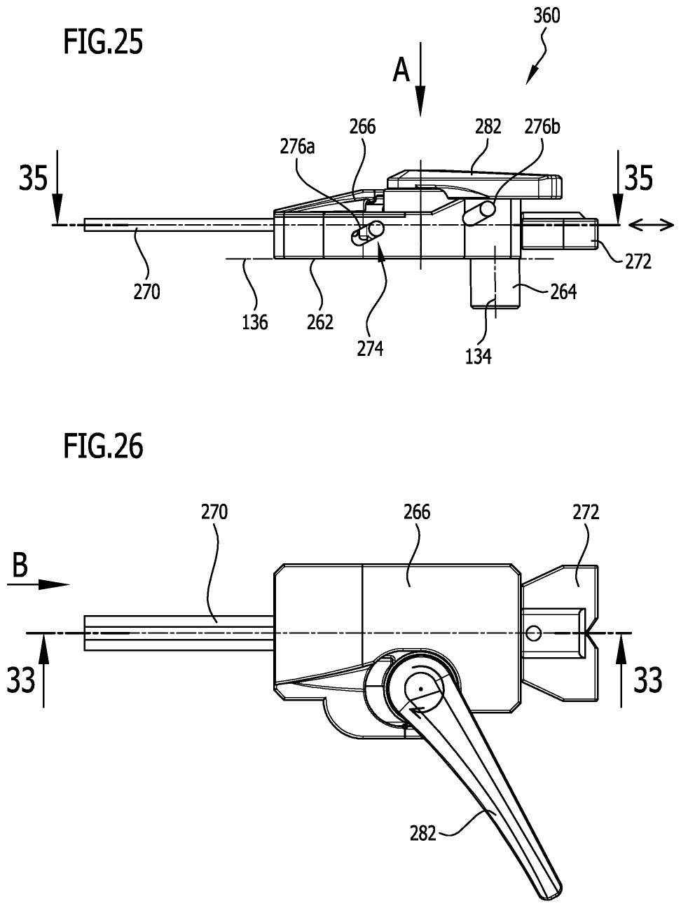

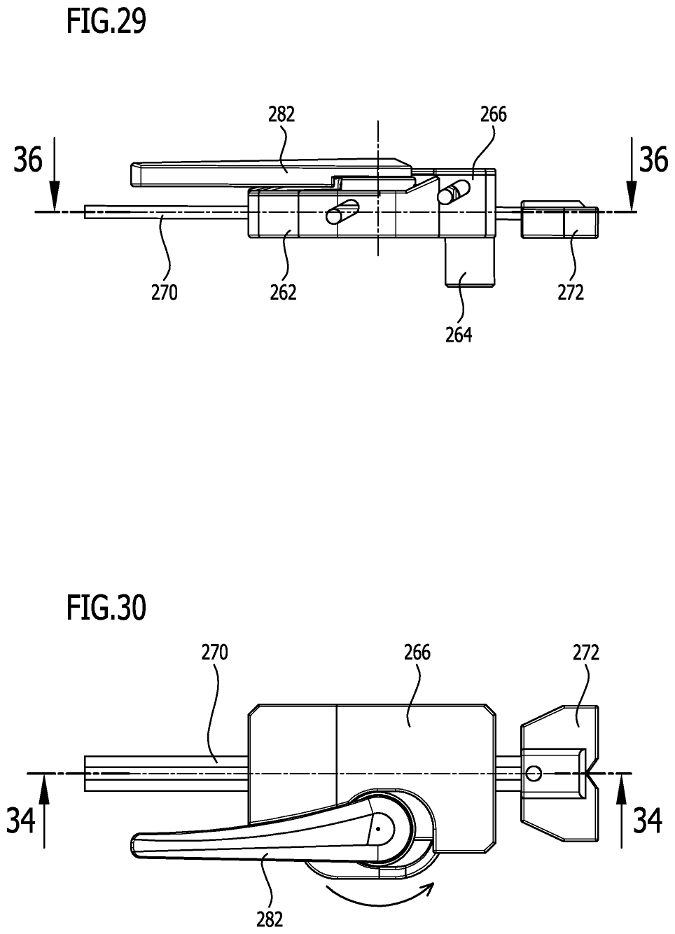

A third exemplary embodiment of a clamping apparatus in accordance with the invention is shown in FIGS. 25 to 36 and designated therein by reference numeral 260. In FIGS. 25 to 28, 33, 35, a non-clamping state corresponding to the non-clamping state 108 in the case of the clamping apparatus 106 is shown. FIGS. 29 to 32, 34, 36 show a clamping state corresponding to the clamping state 110 in the case of the clamping apparatus 106.

The clamping apparatus 260 comprises a holding body 262 with a bolt 264, generally wherein the configuration thereof is identical to that described for the clamping apparatus 192.

Located at the holding body 262 is a housing 266. A guide element 268 (guide element slide 268) is supported for displacement on the holding body 262. In turn, supported for displacement on the guide element is a clamping rail 270 having a pressure piece 272. The clamping rail 270 has a displacement axis.

The guide element 268 is supported for displacement via a displacement bearing 274. The displacement bearing 274 comprises an elongated hole guide. In particular, first elongated holes 276a and second elongated holes 276b are formed at the housing in an opposing relation to each other.

Corresponding pins are located at the guide element 268, which pins enter into the associated elongated holes 276a and 276b.

The elongated holes 276a and 276b are positioned at the holding body 262/housing 266 in spaced relation to each other in a direction parallel to the displacement axis.

The first elongated holes 276a and the second elongated holes 276b have an axis which is oriented at an oblique angle with respect to the height axis 134 of the bolt 264.

The elongated holes 276a and 276b are at different heights relative to the bolt 264, with respect to the height axis 134 (refer to FIG. 25).

Via the displacement bearing 274, the guide element 268 can be displaced in a direction/counter direction 278 (FIG. 28) parallel to a horizontal axis 136. The guide element 268 can further be displaced heightwise, in a direction/counter direction 280 perpendicular to the direction/counter direction 278.

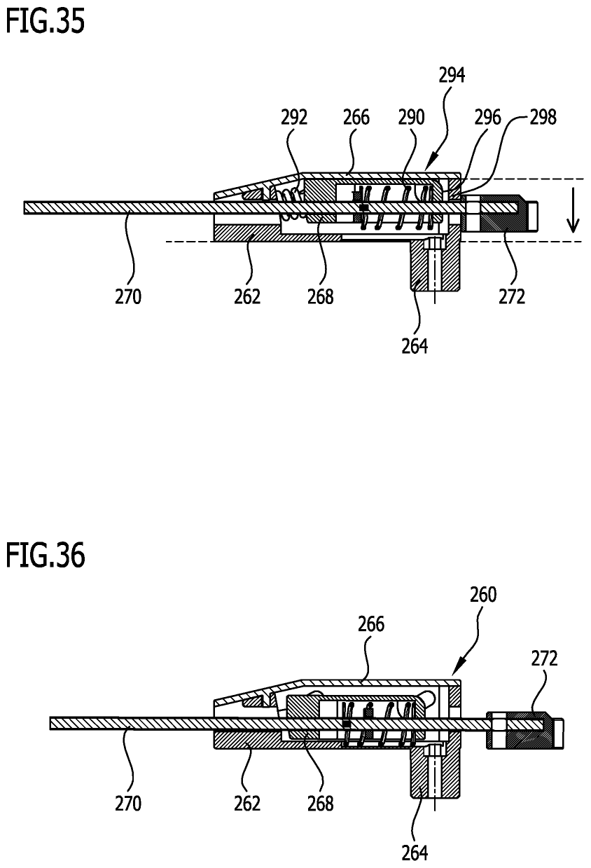

The first elongated holes 276a and the second elongated holes 276b have the same angular position relative to the horizontal axis 136, but are offset in height. They are arranged such that when the guide element 268 is displaced on the displacement bearing 274, the clamping rail 270 does not change its orientation relative to the horizontal axis. In particular, the clamping rail 270 remains parallel to the horizontal axis 136 when the guide element 268 is displaced heightwise (cf. FIGS. 35 and 36).

The clamping apparatus 260 comprises a pivotably arranged clamping lever 282. The clamping lever 282 is pivotably located on the guide element and is displaceable along therewith in the directions/counter directions 278 and 280.

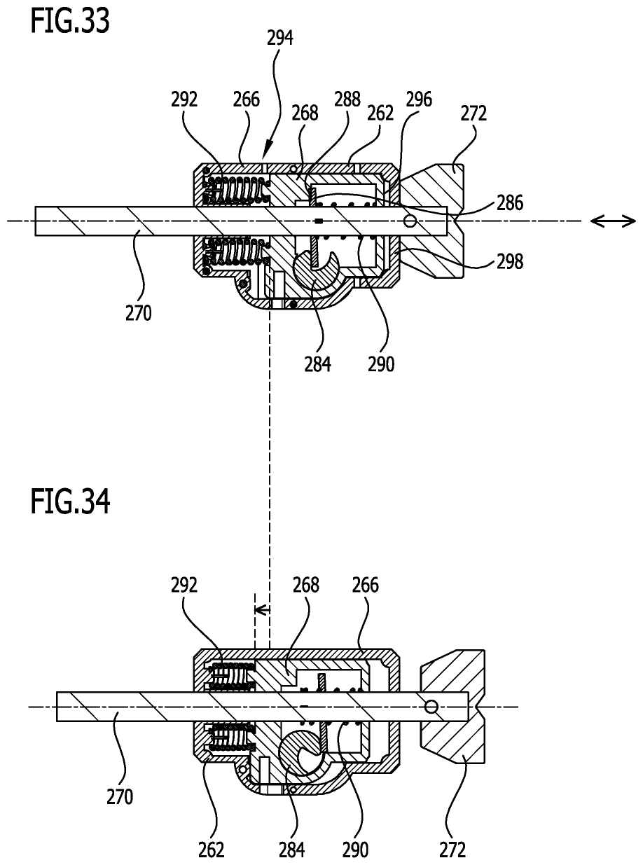

Connected to the clamping lever 282 in rotationally fixed relation therewith is an operative element 284 (FIGS. 33, 34) which is rotatably guided on the guide element 268.

The operative element 284 is configured in the form of an eccentric.

The operative element 284 is configured generally in the same manner as the operative element 162, having a cylindrical outer contour and a cutout.

An advance element 286 is provided which has an opening through which the clamping rail 270 is passed.

In a first position of the clamping lever (FIGS. 25 to 28, 33, 35), the advance element 286 is positioned such that free displacement of the clamping rail 270 on the guide element 268 is rendered possible.

When the operative element 284 is correspondingly rotated (by pivoting the clamping lever 282 out of its first position), the operative element 284 acts by direct contact upon the advance element 286 and cants same relative to the clamping rail 270. Further movement causes the clamping rail to be carried along therewith and, in particular, moved in a forward direction (increasing the distance of the pressure piece 272 from the housing 266).

Arranged at the guide element 268 is a counter element 288 for contact against the advance element 286 (or an advance element package). The counter element 288 is in opposed relation to the operative element 284. The clamping rail 270 is positioned between the counter element 288 and the operative element 284.

In an exemplary embodiment, a first spring device 290 is provided which is supported on the guide element and the advance element 286. The first spring device 290 serves to hold the first position of the clamping lever 282. Its spring force must be overcome.

In the clamping apparatus 260, a second spring device 292 is provided which comprises one or more springs that are supported on the housing 266 and on an opposite end of the guide element 268 (FIGS. 33 and 34).

In the first position of the clamping lever 282, the guide element 268 is in a first position 294. In said first position 294, the guide element 268 has a first end 296 thereof in closer proximity to a first end 298 of the housing 266 (FIG. 33).

When the clamping lever 282 is actuated, namely out of its first position, the guide element 268 is displaced out of its first position 294; in this process, it has its first end 296 displaced away from the first end 298 of the housing 266 and is thereby displaced rearwardly (cf. FIG. 33). The clamping rail 270, on the other hand, is displaced forwardly in this process of actuating the clamping lever.

As the guide element 268 is displaced rearwardly, it is also displaced heightwise in a downward direction; as a result, the distance of the pressure piece 272 to the bolt 264 (or to the plate 102) is reduced.

The guide element 268 is supported via the second spring device 292 on the housing 266.

In a forward displacement, the second spring means 292 is compressed (cf. FIG. 34). The second spring device 292 determines the clamping force that is applied in the clamping state. The spring force of the second spring device 292 determines said clamping force.

The clamping apparatus 260 works as follows:

The clamping apparatus 260 is fixed against the plate 102 as has been described previously by causing the bolt 264 to enter the associated opening 104 and contacting the holding body 262 against the plate 102.

The clamping lever is in its first position. The clamping rail 270, which is guided on the guide element 268, is displaced such that the pressure piece 272 is in contact against or is in the proximity of a workpiece that is to be clamped.

The clamping lever 282 is then pivoted out of its first position. The advance element 286 is thereby canted. Advancement of the clamping rail 270 occurs. At the same time, the guide element 268 is urged away from the first end 298 of the housing 266 and is displaced rearwardly. The second spring device 292 is thereby compressed.

In a second position of the clamping lever 282, a blocking action is provided and the corresponding clamping position is secured. The guide element 268 in the second position is supported via the second spring device 292 on the housing 266. A spring force of the second spring device 292 thereby determines an applied clamping force.

When the guide element 268 is displaced in the direction/counter direction 278, it is also displaced heightwise in the direction 280 (cf. FIGS. 35 and 36). The guide element 268 is displaced downwardly in a direction towards the plate 102 and carries the clamping rail along with it. The pressure piece 272 thereby, in a sense, descends in a direction towards the plate 102.

A hold-down force 300 is created (FIG. 32) which provides better fixation of the workpieces.

In the case of the clamping apparatus 260, the elongated holes 276a, 276b are oriented with a different sign relative to the horizontal axis 136 than that used in the case of the clamping apparatus 192 (cf. FIGS. 25 and 13).

In the case of the clamping apparatus 192, the guide element 200 is moved forwardly in the clamping operation, whereas in the case of the clamping apparatus 260, the guide element 268 is moved rearwardly.

This rearward movement in the case of the clamping apparatus 260 is resiliently supported by virtue of the second spring device 292.

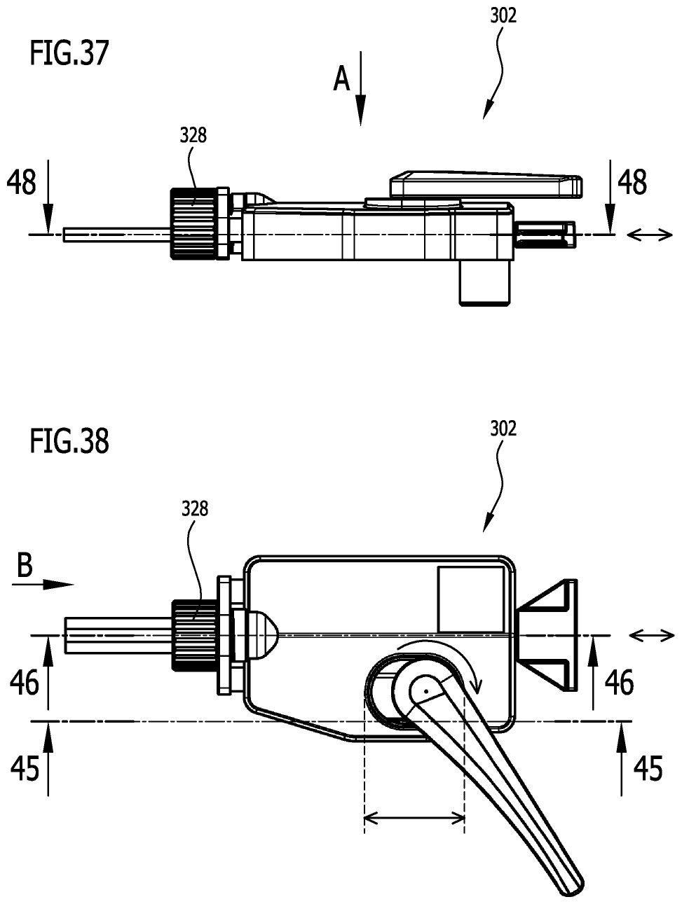

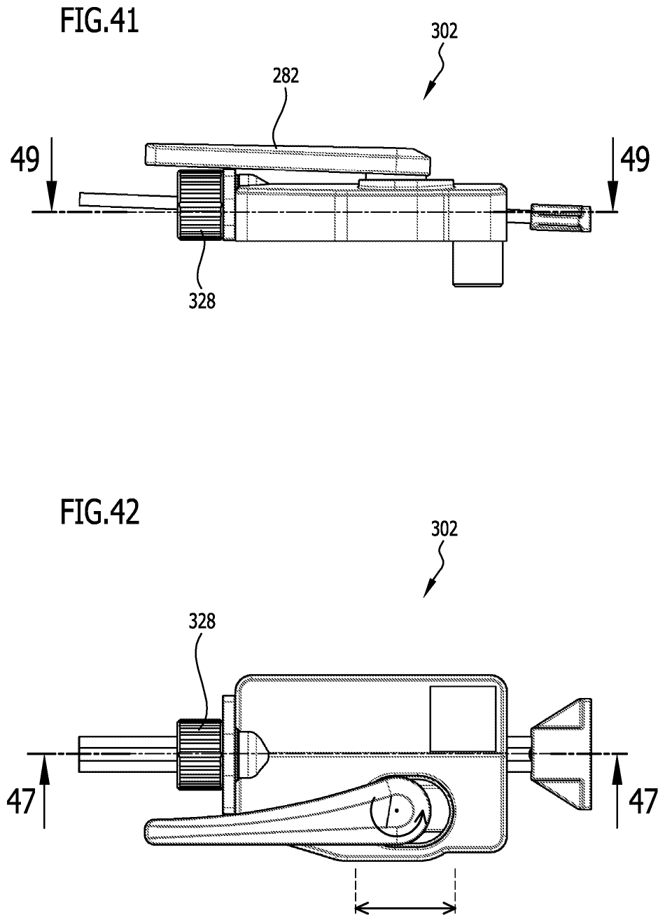

A fourth exemplary embodiment of a clamping apparatus in accordance with the invention is shown in FIGS. 37 to 49 and designated therein by reference numeral 302. In FIGS. 37 to 40, 45, 46, 48, a non-clamping state corresponding to the non-clamping state 108 is shown. FIGS. 41 to 44, 47, 49 show a clamping state corresponding to the clamping state 110.

The configuration of the clamping apparatus 302 is similar to that of the clamping apparatus 260. Like numerals are employed to indicate identical elements.

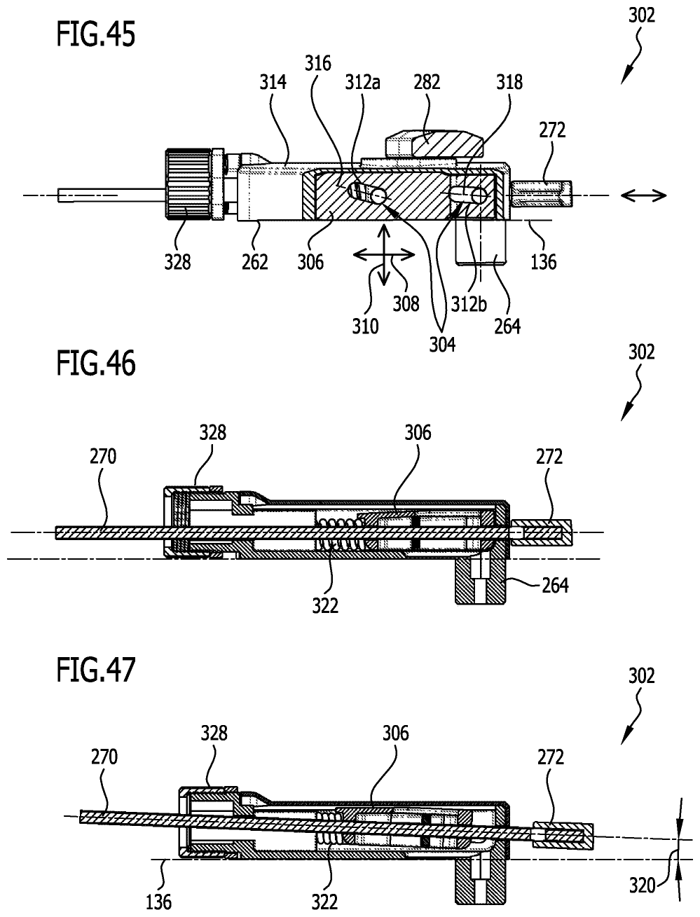

The clamping apparatus 302 differs from the clamping apparatus 260 in matters of displacement bearing configuration. A displacement bearing 304 is provided which permits a corresponding guide element 306 to be displaced in the direction/counter direction 308 and in the direction/counter direction 310 which extends transversely thereto (FIG. 45).

The displacement bearing 304 has first elongated holes 312a in opposing relation to each other at, for example, a housing 314. Furthermore, second elongated holes 312b are provided in opposing relation to one another and in spaced relation to the first elongated holes 312a.

The first elongated holes 312a have a first axis 316 oriented at an oblique angle with respect to the horizontal axis 136. The second elongated holes 312b have a second axis 318 oriented at an oblique angle with respect to the horizontal axis 136.

Here, the oblique orientation of the first elongated holes 312a is different from the oblique orientation of the second elongated holes 312b.

An acute angle by which the first axis 316 is inclined with respect to the horizontal axis 136 is different from the acute angle by which the second axis 318 (of the second elongated holes 312b) is inclined with respect to the horizontal axis 136. In particular, the acute angle by which the first axis 316 is inclined with respect to the horizontal axis 136 is larger than the corresponding acute angle by which the second axis 318 is inclined with respect to the horizontal axis 136.

Here, the second elongated holes 312b having the second axis 318 are in closer proximity to the corresponding bolts 264 or in closer proximity to the pressure piece 272 on the corresponding clamping rail 270.

The guide element 306, on which the clamping rail 270 is displaceably guided, is configured in the form of a slide which is displaceable in the direction/counter direction 308 and is displaceable in the direction/counter direction 310 (height direction).

Because of the different configurations of the elongated holes 312a and 312b, the angular position of the clamping rail 270 in relation to the horizontal axis 136 changes depending on the height position of the guide element 306 at the corresponding holding body 262.

In an initial position, in which a corresponding clamping lever 282 is in a first position, the clamping rail 270 is freely movable relative to the guide element 306 and the clamping rail lies with its displacement axis parallel to the horizontal axis 136 (FIG. 45).

Displacement of the guide element to the rear (cf. FIG. 46) causes the angular position of the clamping rail 270 relative to the horizontal axis 136 to change. In the extreme case of a second position of the clamping lever 282, the clamping rail 270 with its pressure piece lies at an acute angle 320 relative to the horizontal axis 136 (FIG. 47). The acute angle 320 is in particular less than 10° and preferably less than 7° and preferably less than 6°.

Said angle is selected such that the pressure piece 272 will not project beyond an underside of the corresponding holding body 262, where it then might strike the plate 102, for example.

Furthermore, the clamping apparatus 302 comprises a second spring device 322, which is arranged generally in the same manner as the second spring device 292 in the case of the clamping apparatus 260. The second spring device 322 of the clamping apparatus 302 is adjustable.

The contact element 324 is arranged at the holding body 262. The contact element is fixedly connected to the holding body 262. The contact element 324 is located in the area of a rear end of the holding body 262, which rear end is in spaced relation to the pressure piece 272.

The second spring device 322, which comprises one or more springs, is supported on the contact element 324 and on the guide element 306.

The position of the contact element 324 is fixably adjustable. By way of example, the contact element 324 is threadedly held in place to the holding body 262 and a housing connected to the holding body. A distance of the contact element 324 to an end of the guide element 306 facing towards the contact element 324 is adjustable via a threaded position of the contact element 324, relative to the first position of the clamping lever 282.

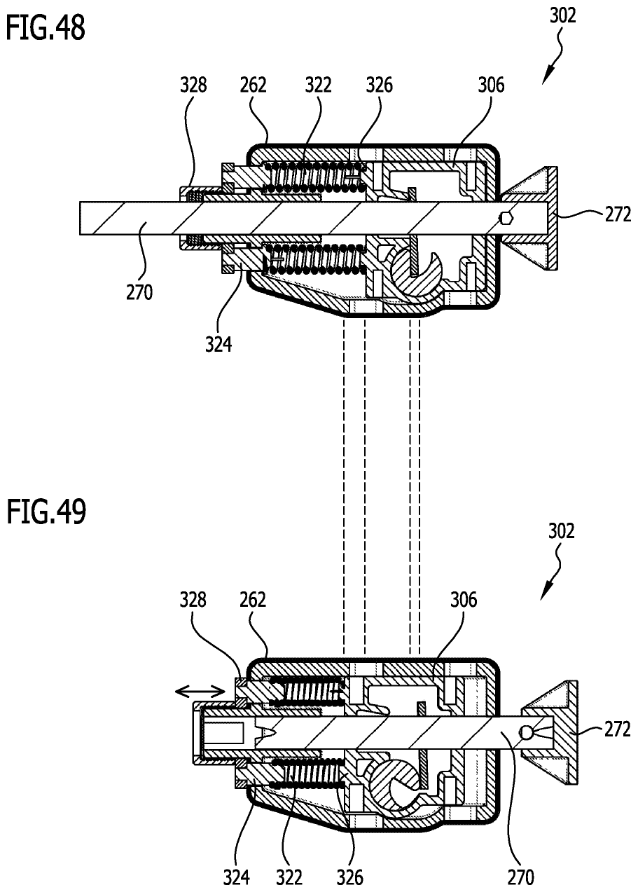

Correspondingly, in the illustration of FIG. 48, which corresponds to a first position of the clamping lever 282, a distance of the contact element 324 to a support side 326 is adjustable. The support side 326 is the side of the guide element 306 that is in opposing relation to the contact element 324 and which provides support to the second spring device 322 on the guide element 306.

A nut, and in particular a union nut 328, is arranged at the holding body 262 or at a housing connected to the holding body. By the rotational position of said nut on the corresponding threads, an entry depth of the contact element 324 in an interior space of the corresponding housing, and hence the distance between the contact element 324 and the support side 326, is predetermined.

The spring force of the second spring device can be adjusted via the position of the contact element 324 which is predetermined by a rotational position of the nut 328. This spring force, in the clamping state 110 of the clamping apparatus 302, determines the magnitude of the clamping force. This clamping force can be fixably varied.

Otherwise, the clamping apparatus 302 functions in the same way as the clamping apparatus 260. When a workpiece is clamped, a hold-down force 330 (FIG. 44) is created by the height mobility of the guide element 306, and hence of the clamping rail 270, and, hence, in turn of the pressure piece 270 relative to the bolt 264, which hold-down force 330 urges the clamping apparatus 302 against the plate 102.

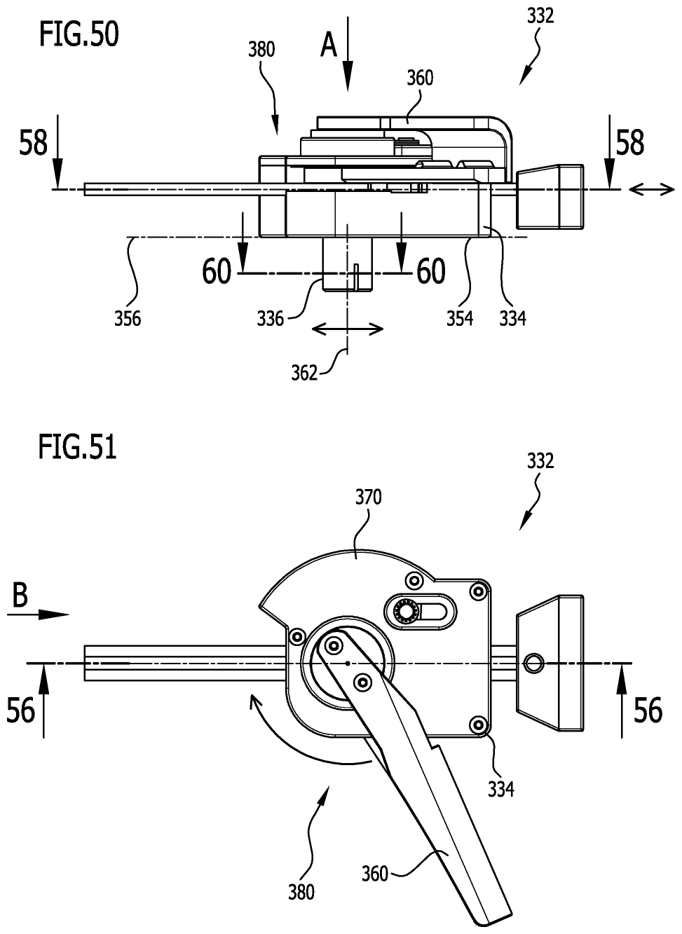

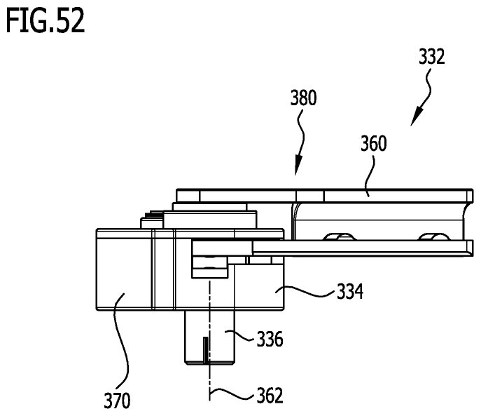

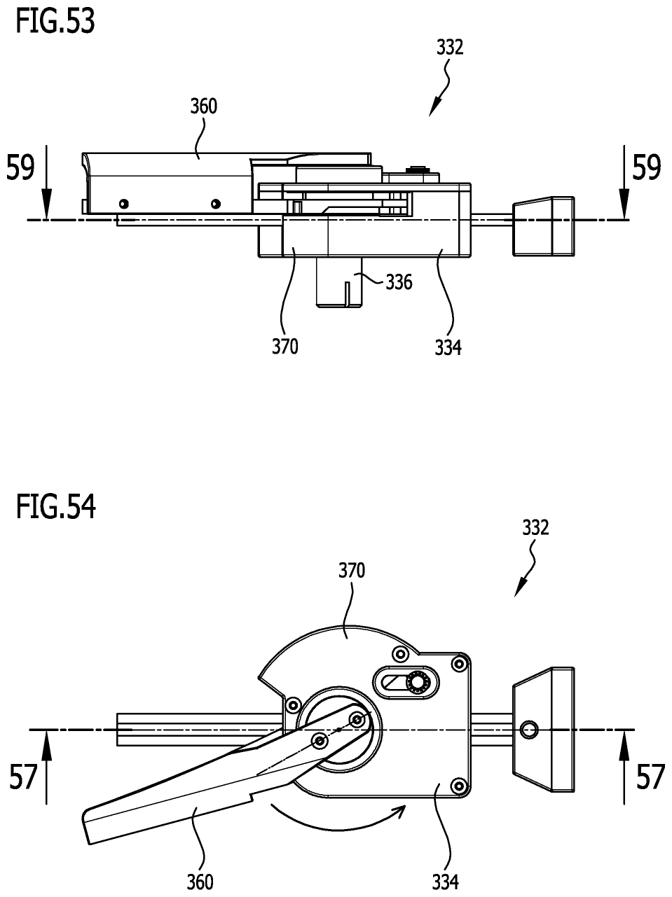

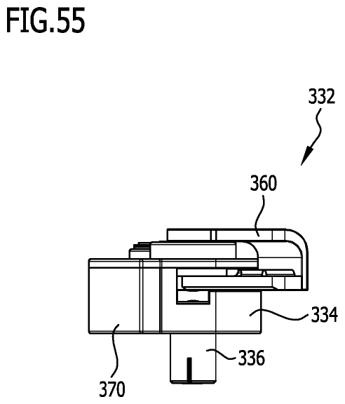

A fifth exemplary embodiment of a clamping apparatus in accordance with the invention is shown in FIGS. 50 to 60 and designated therein by reference numeral 332. In FIGS. 50 to 52, 56, 58, a non-clamping state corresponding to the non-clamping state 108 is shown. FIGS. 53 to 55, 57, 59 show a clamping state corresponding to the clamping state 110.

The clamping apparatus 332 comprises a holding body 334 at which is located a bolt 336. The bolt 336 projects perpendicularly with respect to the holding body 334, wherein the bolt, as before described, is provided for entering an opening 104 of the plate 102 and wherein the holding body 334 is provided for being supported on the plate 102.

The bolt 336 is configured in multi-segmented form (cf. FIG. 60). It includes at least a first segment and a second segment, which segments are movable relative to one another.

In the exemplary embodiment as illustrated (FIG. 60), the bolt 336 comprises three segments, namely a first segment 338a, a second segment 338b, and a third segment 338c. The three segments 338a, 338b, 338c are spaced apart from one another. They are spaced with a gap 340 between each of them. The segments 338a, 338b, 338c are uniformly spaced around the periphery.

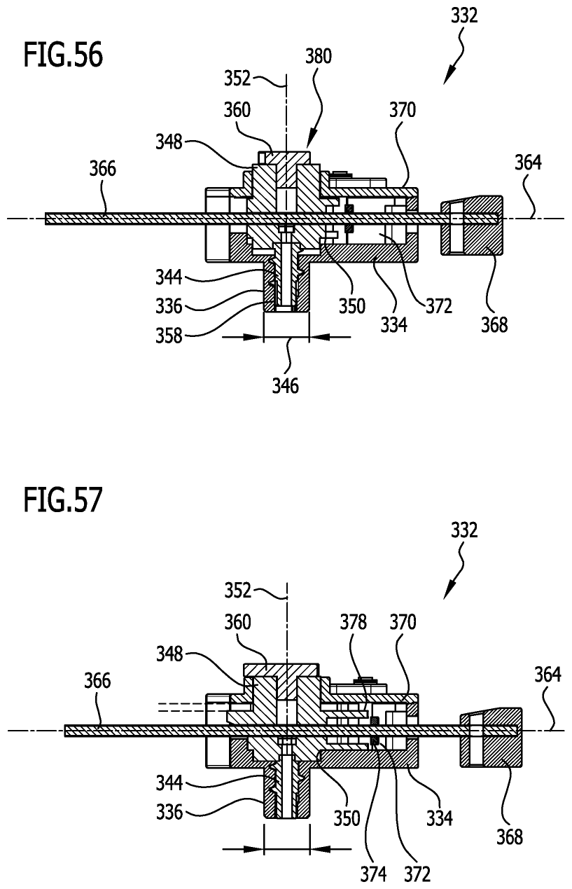

The segments 388a, 338b, 338c enclose a cavity 342. Located in the cavity 342 is an expanding element 344 via which a force can be exerted on the segments 338a, 338b, 338c via which these can be expanded. By virtue of the expanding element 344, a diameter 346 (cf. FIGS. 56, 57) of the bolt 336 can be enlarged. It is thereby possible, when in a clamping state 110, for the segments 338a, 338b, 338c of the bolt 336 to be urged against a wall of the opening 104 in order to obtain an additional force-locking anchoring of the bolt 336 in the associated opening 104.

A guide element 348 is arranged at the holding body 334 (cf. FIGS. 56, 57). Here, the guide element 348 is positioned for rotary movement. It is supported on the holding body 334 via a rotary bearing 350.

An axis of rotation 352 (FIGS. 56, 57) of the rotatability of the guide element 348 on the holding body 334 extends transversely and in particular perpendicularly with respect to a contact surface 354 of the holding body 334 against the plate 102. The contact surface 354 defines a horizontal axis 356.

In an exemplary embodiment, the rotary bearing 350 comprises a thread 358, and in particular comprises a trapezoidal thread and a sliding bearing.

A clamping lever 360 is located at the guide element 348 in rotationally fixed relation therewith. An axis of rotation of the clamping lever 360 corresponds to the axis of rotation 352.

The axis of rotation 352 is parallel to a height axis 362 of the bolt 336.

In particular, when the clamping apparatus 332 is correctly positioned against the plate 102, then the clamping lever 360 is positioned at least approximately parallel to a plate plane. The axis of rotation 352 is oriented at least approximately perpendicularly to a plate plane.

The expanding element 344 is located at the guide element 348 in rotationally fixed relation therewith, within the bolt 336 and between the segments 338a, 338b, 338c. The expanding element 344 acts on the segments 338a, 338b, 338c such that, caused by a rotational movement of the expanding element 344 (initiated via a rotational movement of the clamping lever 360 which causes rotational movement of the guide element 348), the bolt 336 is expanded to increase the diameter 346 thereof. Alternatively or in addition, it is possible for the expanding element 344 to be arranged and formed such that, caused by a height movement of the spreading element 344 in response to a height movement of the guide element 348, the bolt 336 is expanded by action upon the segments 338a, 338b, 338C.

As an example, a sliding block guide is provided at the segments 338a, 338b, 338c, wherein one or more elements fixedly connected to the expanding element 344, such as webs, are guided on the sliding block guide and effect a corresponding expansion upon rotary movement and/or height movement.

If the expanding element 344 acts upon all of the segments 338a, 338b, 338c of the bolt 336, uniform clamping against a corresponding opening 104 is achieved. In principle, it is also possible for the expanding element 344 to not act upon all of the segments and, for example where three segments are used, to act only on one segment or two segments. This also achieves the effect of increasing the diameter of the bolt 336 in order to achieve a clamping force for the bolt 336 in the associated opening 104.

A clamping rail 366 is displaceably guided on the guide element 348 in a displacement axis 364. The clamping rail 366 has, in the region of one end, a pressure piece 368 for acting upon a workpiece.

The clamping rail 366 is guided on the guide element 348 such that it is free with respect to the rotational movement of the guide element 348, meaning that it does not co-rotate with the guide element 348. With respect to the height movement in the height axis 362, by virtue of the fact that the guide element 348 is threadedly arranged at the holding body 334, the clamping rail 366 is guided such that it moves with the guide element 348 in said height movement.

Therefore, by virtue of the guide element 348, the clamping rail 366 is heightwise movable parallel to the height axis 362. In particular, in a clamping position, the pressure piece 368 can be brought in closer proximity to the bolt 336 or the plate 102. A hold-down force is thereby created which provides secure fixation of workpieces against the plate 102 by way of the clamping apparatus 332.

In particular, with respect to the height axis 362, provision is made for the clamping rail 366 to be held in place to the guide element 348 in form-locking relation therewith so that the clamping rail 366 (and hence the pressure piece 368) correspondingly moves along with the guide element 348 in its movement in the height direction (parallel to the height axis 382).

The holding body 334 comprises a housing 370 or has formed thereon a housing 370. The housing 370 has an interior space 372. An advance element 374 or advance element package is arranged in the interior space 372. The advance element 374 is located at the clamping rail 366. The clamping rail 366 is passed through an opening 376 of the advance element 374. The advance element 374 is in particular of plate-like shape and is in particular a sheet metal part. In particular, in an advance element package, a plurality of plate-shaped sheet metal parts are provided.

Connected to the clamping lever 360 in a rotationally fixed relationship therewith is a disc element (operative element) 378. The disc element 378 co-rotates with rotation of the clamping lever 360. The disc element 378 is configured as an eccentric.

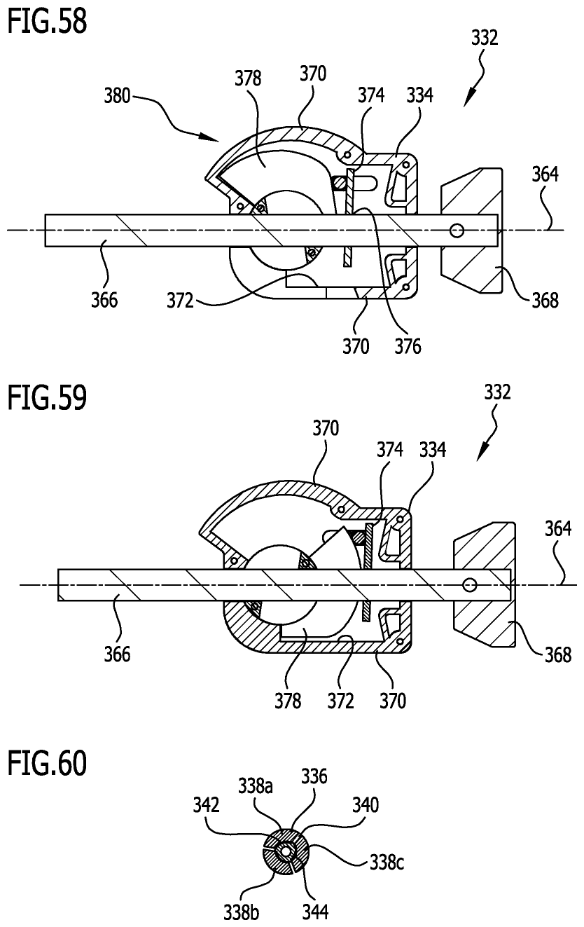

The clamping lever 360 has a first position 380 (FIGS. 50 to 52, 56, 58), in which position the advance element 374 is positioned such that the clamping rail 366 is freely displaceable with respect to the guide element 348 and also with respect to the housing 370, along the displacement axis 364 (FIGS. 56, 58). In particular, the advance element 364 is oriented transversely and in particular perpendicularly with respect to the clamping rail 366 such that the latter is freely displaceable through the opening 376.

When the clamping lever 360 is moved out of its first position, the disc element rotates relative to the holding body 334 (and the housing 370). The disc element 378, which is configured in the form of an eccentric, directly contacts the advance element 374. The rotation will first cause the advance element 374 to cant relative to the clamping rail 366. Continued rotation causes the advance element 374 to advance under conditions where the advance element 374 is canted relative to the clamping rail 366. Thereby, via a forward movement of the advance element 374, the clamping rail 366 is carried along therewith and moved forwards. Here, a backward movement of the pressure piece 368 towards the housing 370 is blocked.

In the corresponding rotational movement of the clamping lever 360 out of the first position 380, the clamping rail 366 is then displaced forwards (in a direction in which the distance of the pressure piece 368 from the housing 370 increases).

At the same time, the guide element 348 is lowered on the thread 358 in the height axis. The clamping rail 366 is carried along therewith, and the pressure piece 368 descends in a direction towards the plate 102.

Furthermore, the expanding element 344 co-rotates and descends. This effects expansion of the bolt 336.

The clamping apparatus 332 is positioned against the plate 102. The bolt 336 is entered into the opening 104, and the holding body 334 is contacted against an upper side of the plate 102. To initiate a clamping operation, the clamping lever 360 is in the first position 380. The clamping rail 366 is freely displaceable in the axis of displacement 364. A user moves the pressure piece 368 against a workpiece that is to be clamped, until the pressure piece 368 is in contact against, or just ahead of, the workpiece.

An operator pivots the clamping lever 360 out of the first position 380 thereof (cf. FIGS. 56, 57 and 58, 59). As a result of this, the disc element 378 acts upon the advance element 374, cants the latter and effects forward displacement (parallel to the displacement axis 364) of the advance element 374, and hence the clamping rail 366. The pressure piece 368 moves away from the housing 370, or causes a pressure force.

At the same time, by virtue of this rotation, the guide element 348 is lowered along the height axis 362 and a hold-down force is created.

Furthermore, the bolt 336 is expanded and clamped in place against the corresponding opening 104.

In particular, a second position of the clamping lever 360 is provided (cf. FIG. 59). When in this position, the clamping lever 360 is blocked.

The clamping apparatus 332 has been described as having the guide element 348 thereof supported for rotation on the holding body 334 and supported for height movement. The expansion force for expanding the bolt 336 via the expanding element 344 can be realized via the rotary movement and/or via the height movement.

It is in principle also possible for no capability for height displacement to be provided and, for example, for a corresponding expanding element to be directly connected to an associated clamping lever in rotationally fixed relation therewith. A rotational movement of the clamping lever then effects expansion of the bolt without additional height displacement by correspondingly guiding, as by a sliding block guide, the expanding element on a multi-segmented bolt.

A clamping apparatus in accordance with the invention comprises a holding body with a bolt. Here, the bolt can be fixedly connected to the corresponding holding body, and can, for example, be connected therewith in one piece or subsequently joined thereto, for example by welding.

In an exemplary embodiment, the bolt is fixably removably arranged at the holding body. This is explained in connection with the clamping apparatus 192 (second exemplary embodiment). In principle, however, this variant can be implemented on all clamping apparatuses in accordance with the invention.

The bolt 196 is fixably removably arranged at the holding body 194. This provides easy replacement of the bolt 196. In particular, a set of different bolts 196 is then provided in order to afford adaptability of the clamping apparatus 192 to a respective plate 102 with its openings 104. Here, different bolts 196 differ in their diameter and/or in their length.

In the exemplary embodiment of the clamping apparatus 102, an insertion guide 386 (cf. FIGS. 21, 22) is arranged at the holding body 104. The bolt 196 has a counter element 388 for the insertion guide 386. The bolt 196, with its counter element 388, is insertable into the insertion guide 386. Here, an insertion direction 390 is transverse and in particular perpendicular with respect to the displacement axis 208 of the clamping rail 206 (cf. FIG. 16). The insertion direction 390 is transverse and in particular perpendicular to the height axis 134 of the bolt 196.

In particular, associated with the insertion guide 386 is a stop which prevents the bolt 196 from being “pushed through” at the insertion guide 386.

Preferably, the counter element 388 has transverse dimensions that are larger than the bolt 196 and has transverse dimensions larger than the openings 102. The bolt 196 can then be inserted in an opening 104, and the counter element 388 is in contact against a plate region around the opening 104; the bolt cannot fall through. When the bolt 196 is inserted in the opening 104, the holding body 194 can be slid onto the bolt 196.

It is also possible for the corresponding bolt 196 to be fixably removably fixed to the holding body 194 in other ways.

As an example, the bolt 196 is threadably fixed to the holding body 194, wherein the bolt 196 is removable from the holding body 194.

By providing a set of bolts having different diameters and/or lengths, a high variability is provided for the corresponding clamping apparatus 192 or for the other clamping apparatuses where these are provided with fixably removable bolts.

One or more workpieces can be clamped against the plate 102, between a clamping apparatus in accordance with the invention and a counter element. In accordance with the invention, a contact apparatus can be provided as a counter element, which causes a hold-down force to be applied to the contact apparatus in the clamping operation.

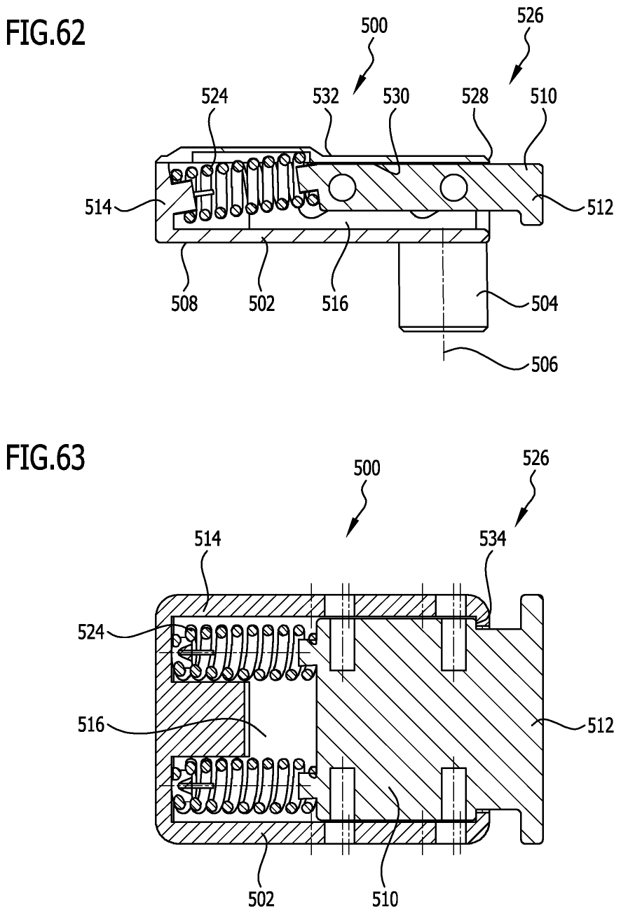

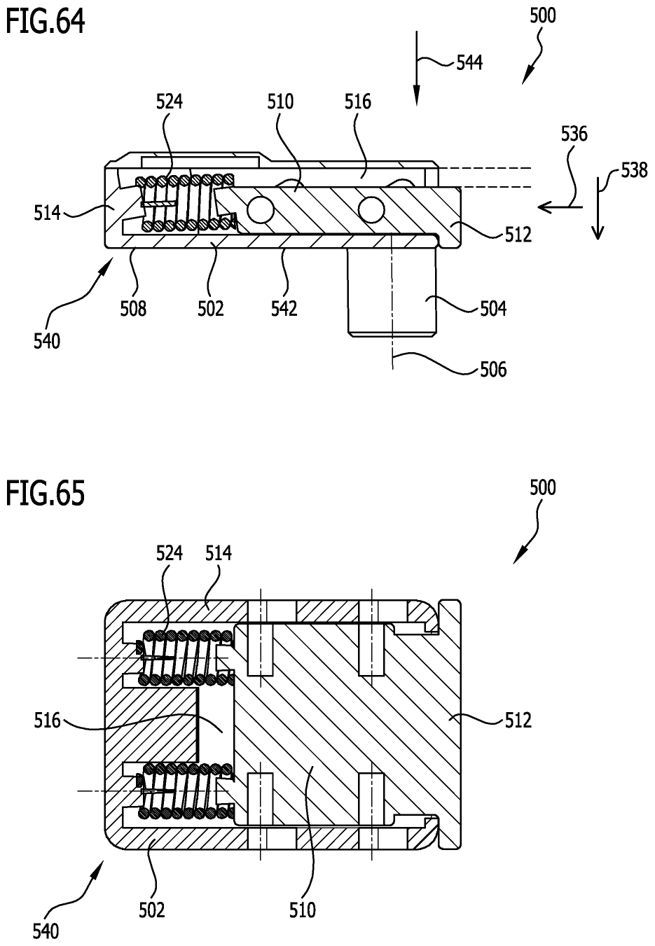

A first exemplary embodiment of a contact apparatus 500 in accordance with the invention is shown in FIGS. 61 to 65. Here, a basic state (non-clamping state) is shown in FIGS. 61 to 63, whereas a clamping state is shown in FIGS. 64, 65. The workpiece, which is required in the clamping state, has been omitted from FIGS. 64, 65.

The contact apparatus 500 comprises a holding body 502 on which a bolt 504 is located. The bolt 504 projects with a height axis 506 thereof transversely and in particular perpendicularly from the holding body 502, and in particular from an underside 508 of the holding body 502.

The underside 508 is configured for contact against the plate 102.

The bolt 504 under these conditions is then entered in the corresponding opening 104 of the plate 102.

A contact element 510 is movably arranged at the holding body 502. The contact element 510 has a contact surface 512 for contact against a workpiece. The contact element 510 is the equivalent of a pressure piece in a clamping apparatus in accordance with the invention.

The contact element 510 is guided for displacement on the holding body 502, and, here, is guided for heightwise displacement and displacement in a longitudinal direction.

The holding body 502 has a housing 514 or is connected to a housing 514. An interior space 516 is defined by the housing 514. The housing 514 is open to one side, and the contact element 510 has its contact surface 512 projecting out of this side.

The contact element 510 is guided for displacement relative to the holding body 502 via a displacement bearing 518. In particular, the displacement bearing 518 is formed at the housing 514.

In an exemplary embodiment, the displacement bearing 518 comprises elongated hole guides. To this end, first elongated holes 520a are formed in an opposing relation to each other at the housing 514 and, in spaced relation thereto, second elongated holes 520b are formed in opposing relation to each other (FIG. 61).

The first elongated holes 520a and the second elongated holes 520b are in spaced relation to each other relative to a longitudinal axis 522 of the holding body 502.

Corresponding pins are located at the contact element 510, which pins enter into the elongated holes 520a and 520b.

The elongated holes 520a, 520b are oriented at an oblique angle with respect to the longitudinal axis 522. They are located at an acute angle which is for example of the order of 30° with respect to the longitudinal axis 522.

The displacement bearing 518 is configured such that displacement can be realized both parallel to the longitudinal axis and perpendicularly to the longitudinal axis (parallel to the height axis 506) of the contact element 510, relative to the holding body 502.

The contact element 510 is supported on the holding body 502 via a spring device 524. The spring device 524 is configured such that it holds the contact element 510 in a first position 526 (FIGS. 61 to 63). In this first position 526, the contact element 510 has its maximum dimensions along the longitudinal axis 522. The contact element 510 is maximally extended out of the corresponding opening of the housing 514. The contact surface 512 is maximally spaced apart from a front side 528 of the housing 514. The opening from which the contact element 510 emerges from the housing 514 is formed at the front side 528.

In particular, the contact element 510 is in contact against an inner side 530 of a housing cover 532 when in the first position 526.

Furthermore, a contact device 534 is provided that defines the maximum deflection parallel to the longitudinal axis 522 of the contact element 510 at the housing 514.

By way of example, the contact device 534 is formed by way of a shoulder at the contact element 510 and a corresponding counter element at the housing 514 (cf. FIG. 63).

To effect displacement of the contact element 510 out of the first position 526, the spring force of the spring device 524 must be overcome.

In particular, the spring device 524 comprises one or more springs.

When, starting from the first position 526, the contact element 510 is displaced further inwardly into the housing 514 (FIGS. 64, 65), the contact element 510 is moved in a direction 536 (FIG. 64) which is transverse and in particular perpendicular to the height axis 506. Furthermore, height movement occurs in a direction 538 which is perpendicular to the direction 536 and parallel to the height axis 506.

When, starting from the first position 526, the contact element 510 is displaced, a distance of the contact surface 512 to the bolt 504, and hence to the plate 102, is reduced (FIGS. 64, 65).

The contact element 510 has a maximum second position 540 (FIGS. 64, 65) in which the contact element 510 is in contact against a bottom 542 of the housing 514; the bottom 542 is opposite the housing cover 532.

A contact device is further formed in that the corresponding pin elements are in contact against the elongated holes 520a, 520b on the front sides thereof.

When a workpiece is clamped between a clamping apparatus and a contact apparatus 500 in accordance with the invention and when a corresponding clamping force is exerted, this then effects a displacement of the contact element 510. A height displacement is also realized via the displacement bearing 518; the contact element 510 has height mobility with respect to the holding body 502.

By virtue of this height mobility, a hold-down force 544 is generated at the contact apparatus 500 in a direction of the plate 102, thus providing better fixation of workpieces against the plate 102.

The displacement of the contact element 510 on the displacement bearing 518 is effected directly by an operator or by an opposing clamping apparatus. In particular, starting from the first position 526 of the contact element 510, when the contact element 510 is in contact against a workpiece, a clamping force of the clamping apparatus is transmitted thereto through the intermediacy of the workpiece, which clamping force displaces the contact element 510 further into the housing 514 and displaces the contact element 510 downwardly in the height axis 506. This in turn generates the hold-down force 544.

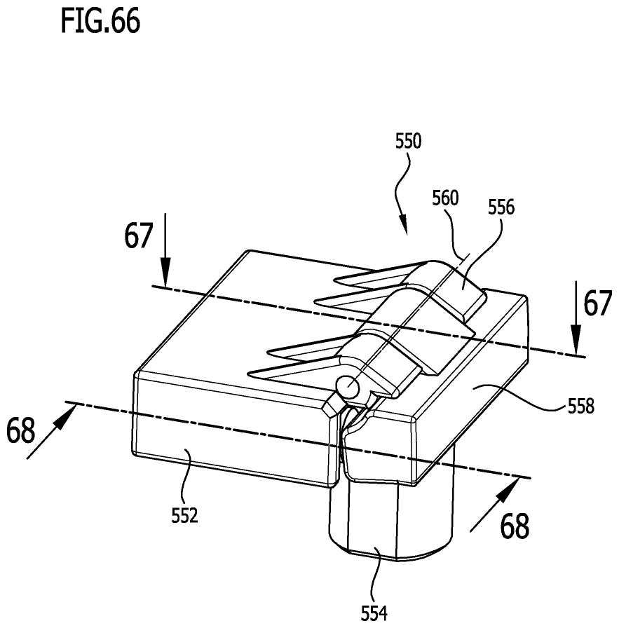

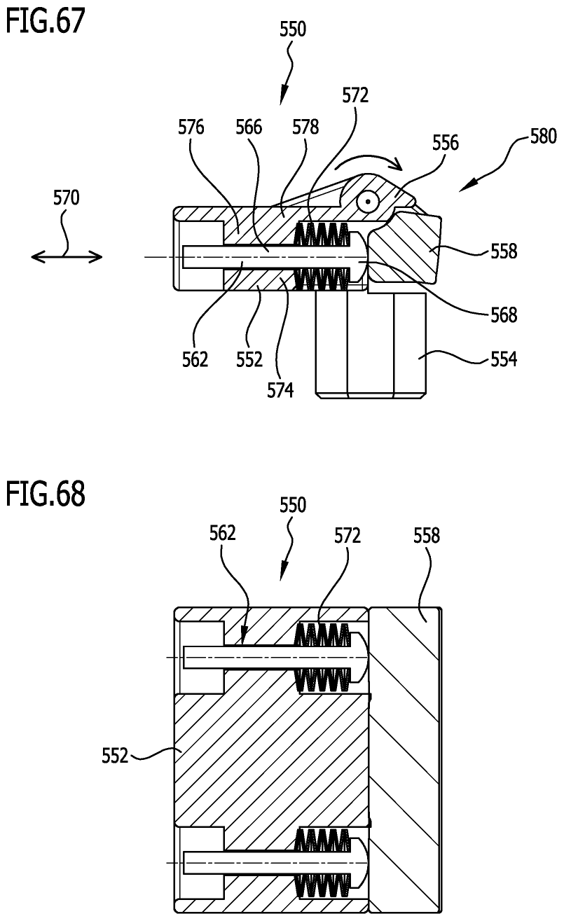

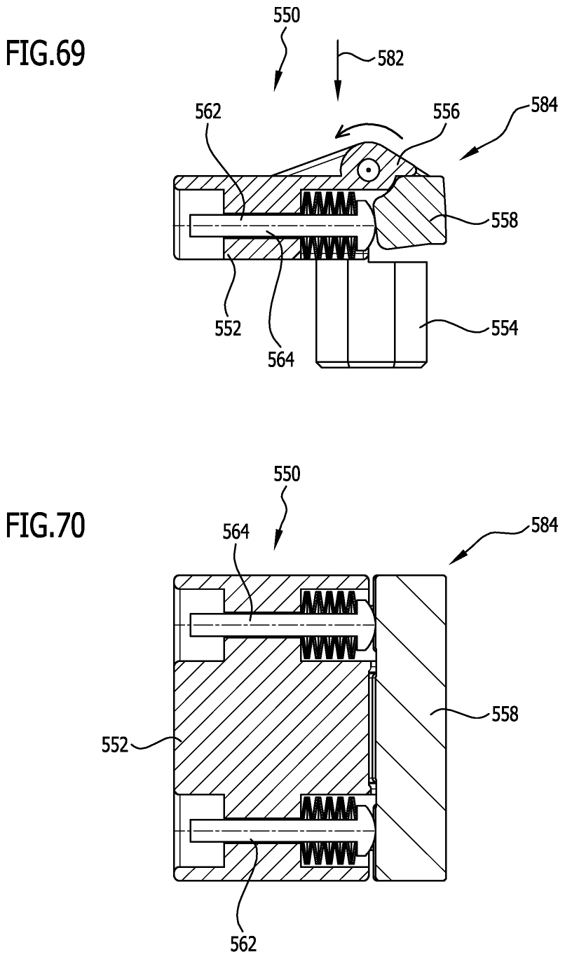

A second exemplary embodiment of a contact apparatus in accordance with the invention is shown in FIGS. 66 to 70 and is designated therein by the reference numeral 550. Here, a non-clamping state is shown in FIGS. 66 to 68, whereas a clamping state is shown in FIGS. 69, 70.

The contact apparatus 550 comprises a holding body 552 which has a bolt 554 projecting transversely therefrom.

The bolt 554 is provided for entering an opening 502, and the holding body 552 is provided for contact against the plate 102.

Located at the holding body is a pivot bearing 556. Pivotably positioned on the pivot bearing is, in turn, a contact element 558 having a contact surface for a workpiece. A pivot axis 560 of the pivot bearing is oriented transversely and in particular perpendicularly with respect to a height axis of the bolt 554.

The pivot bearing 556 is located in spaced relation to the bolt 554. In particular, the contact element 558 is positioned between the pivot bearing 556 and the bolt 554.

A plunger device 562 is supported for displacement on the holding body 552. The plunger device 562 has one or more plungers 564. In the exemplary embodiment 550, two plungers are provided, these being spaced apart in a transverse direction of the holding body 552.

A plunger 564 comprises a rod 566 and a head 568. The rod 566 is supported for displacement, particularly sliding displacement, on the holding body 552. A displacement direction 570 is transverse and in particular perpendicular to the height axis of the bolt 554. The head of the respective plunger 564 acts upon the contact element 558.

A respective plunger 564 is supported on the holding body 552 via a spring device 572.

In an exemplary embodiment, the holding body 552 comprises a linear displacement bearing, wherein the rod 566 is guided in an opening 576 of the linear displacement bearing 574. The opening 576 is surrounded, in a direction towards the contact element 558, by a wall 578. The spring device 572 is supported on said wall 578 and on a side of the head 568 that faces away from the contact element 558. The side of the head 568 that faces towards the contact element 558 contacts the contact element 558.

The spring device 572 is configured such that it urges the respective plungers 564 of the plunger device 562 into a first position 580 of the contact element 558. In the first position 580 of the contact element 558, the contact element 558 is contacted against the holding body 552 and for example against a housing of the holding body 552.

In order to move the contact element 558 out of the first position, the spring force of the spring device 572 must be overcome (FIGS. 69, 70).

To effect the movement out of the first position 580, the contact element 558 is pivoted on the pivot bearing 556 about the pivot axis 560 in a direction towards the wall 578, wherein, as has been mentioned above, the spring force of the spring device 572 must be overcome (FIGS. 69, 70).

A contact surface against a workpiece of the contact element 558 thereby projects to a lesser extent beyond the holding body 552.

When the contact element 558 is pivoted, the contact surface thereof is moved towards the bolt 554. By virtue of the pivoting, the contact element 558 has a movement in a height component, i.e., parallel to the height axis of the bolt 554.

When a workpiece is clamped, then, by virtue of this component of movement parallel to the height axis of the bolt 554, a hold-down force 582 can be generated that provides better fixation of workpieces against a plate 102.

Shown in FIGS. 66 to 68 is an initial position of the contact element 558 prior to clamping a workpiece. The contact element 558 with its contact surface is in the first position 580. When a workpiece is contacted thereagainst and a corresponding pressure force is applied, the contact element 558 can pivot in a direction towards the bolt 554. The hold-down force 582 is thereby generated.

The contact element 558 has a marked second position 584 in which, starting from the first position 580, a maximum pivoting angle is reached.

In principle, provision can be made (although not shown in the drawings) for a contact apparatus in accordance with the invention to comprise a clamping lever which is associated with a bolt. In particular, a bolt is then configured in multi-segmented form having at least a first segment and a second segment. An expanding element is provided which is connected to the clamping lever, and in particular is connected thereto in a rotationally fixed relation. The clamping lever is rotatable. By rotation of the clamping lever, a bolt can be expanded via the expanding element to provide for additional clamping of a bolt against an opening 104.

In accordance with the invention, a clamping apparatus is provided and a contact apparatus is provided which, when one or more workpieces are clamped, effect an additional hold-down force which provides improved fixation of workpieces against a plate 102 and, in particular, prevents the clamping apparatus and the contact apparatus from lifting off.

In accordance with the invention, a workpiece is clamped between a clamping apparatus and a contact apparatus such that a first contact region of the clamping apparatus is in contact against the workpiece and a second contact region of the contact apparatus is in contact against the workpiece. A clamping rail having a pressure piece as the first contact region is urged against the workpiece via a clamping lever of the clamping apparatus. By virtue of a height mobility of the pressure piece of the clamping rail relative to the corresponding bolt of the clamping apparatus and/or by virtue of a height mobility of a contact element of the contact apparatus, at which contact element the second contact region is formed, a hold-down force can be generated at the clamping apparatus and at the contact apparatus which urges clamped workpieces against the plate 102. This hold-down force is essentially only generated when a workpiece is clamped.

Alternatively or in addition, provision can be made for a bolt of the clamping apparatus to be expanded in a clamping operation in order to achieve clamping of the bolt against an opening 104 of the plate 102.

In the method in accordance with the invention, a clamping apparatus in accordance with the invention and a contact apparatus in accordance with the invention can be used in combination. It is possible in principle for a clamping apparatus in accordance with the invention to be used alone or for a contact apparatus in accordance with the invention to be used alone.

### LIST OF REFERENCE CHARACTERS

102 plate
104 opening
106 clamping apparatus (first exemplary embodiment)
108 non-clamping state
110 clamping state
112 holding body
114 underside
115 contact surface
116 bolt
118 longitudinal axis
120 first end
122 second end
124 portion
126 clamping rail
128 guide element
130 displacement axis
132 pressure piece
134 height axis
136 horizontal axis
138 opening
140 height direction
142 pivot bearing
144 bridge
145 pivot axis
146 first position
148 second position
150 underside
152 acute angle
154 front region
156 clamping lever
158 pivot bearing
160 pivot axis
162 operative element
164 advance element
166 opening
168 outer contour
170 receptacle
172 cutout
174 wall
176 first position
178 counter element
180 second position
182 contact
184 contact apparatus
186 workpiece
188 hold-down force
190 housing
192 clamping apparatus (second exemplary embodiment)
194 holding body
196 bolt
198 housing
200 guide element
202 displacement bearing
204 direction/counter direction
206 clamping rail
208 displacement axis
210 direction/counter direction
212 pressure piece
214 elongated hole guide
216a first elongated hole
216b second elongated hole
218 longitudinal axis
220 acute angle
222 clamping lever
224 pivot bearing
226 pivot axis
228 operative element
230 rotary bearing
232 wall
234 recess
236 advance element
238 counter element
240 forward direction/backward direction
242 rear end
244 distance
246 rear end
248 upper position
250 lower position
252 hold-down force
254 first spring device
256 first position
258 cutout
260 clamping apparatus (third exemplary embodiment)
262 holding body
264 bolt
266 housing
268 guide element
270 clamping rail
272 pressure piece
274 displacement bearing
276a first elongated hole
276b second elongated hole
278 direction/counter direction
280 direction/counter direction
282 clamping lever
284 operative element
286 advance element
288 counter element
290 first spring device
292 second spring device
294 first position
296 first end
298 first end
300 hold-down force
302 clamping apparatus (fourth exemplary embodiment)
304 displacement bearing
306 guide element
308 direction/counter direction
310 direction/counter direction
312a first elongated hole
312b second elongated hole
314 housing
316 first axis
318 second axis
320 acute angle
322 second spring device
324 contact element
326 support side
328 nut
330 hold-down force
332 clamping apparatus (fifth exemplary embodiment)
334 holding body
336 bolt
338a first segment
338b second segment
338c third segment
340 gap
342 cavity
344 expanding element
346 diameter
348 guide element
350 rotary bearing
352 axis of rotation
354 contact surface
356 horizontal axis
358 thread
360 clamping lever
362 height axis
364 displacement axis
366 clamping rail
368 pressure piece
370 housing
372 interior space
374 advance element
376 opening
378 disc element
380 first position
386 insertion guide
388 counter element
390 insertion direction
500 contact apparatus (first exemplary embodiment)
502 holding body
504 bolt
506 height axis
508 underside
510 contact element
512 contact surface
514 housing
516 interior space
518 displacement bearing
520a first elongated holes
520b second elongated holes
522 longitudinal axis
524 spring device
526 first position
528 front side
530 inner side
532 housing cover
534 contact device
536 direction
538 direction
540 second position
542 bottom
544 hold-down force
550 contact apparatus (second exemplary embodiment)
552 holding body
554 bolt
556 pivot bearing
558 contact element
560 pivot axis
562 plunger device
564 plunger
566 rod
568 head
570 displacement direction
572 spring device
574 linear displacement bearing
576 opening
578 wall
580 first position
582 hold-down force
584 second position

What is claimed is:

1. A clamping apparatus for a plate, comprising
a holding body at which a bolt is arranged for entering into an opening of the plate,
a clamping rail which is linearly displaceable relative to the holding body along a displacement axis, and
a pressure piece which is arranged or formed at the clamping rail,
wherein the clamping rail is guided for linear displacement on a guide element which is movably supported on the holding body, and
wherein the guide element is supported for height movement such that a height distance of the pressure piece to at least one of (i) the bolt and (ii) the holding body is dependent on a position of the guide element relative to the holding body, wherein the height distance is transverse to the displacement axis of the clamping rail.

2. The clamping apparatus in accordance with claim 1, wherein the guide element is supported for height movement on the holding body such that the height distance of the pressure piece to at least one of (i) the bolt and (ii) the holding body is smaller in a clamped state in which the clamping apparatus exerts a clamping force upon a workpiece than in an unclamped state in which the clamping apparatus does not exert a clamping force.

3. The clamping apparatus in accordance with claim 1, wherein the guide element is heightwise movable relative to the holding body such that when in a clamped state in which the clamping apparatus exerts a clamping force upon a workpiece, a hold-down force is exerted on the workpiece.

4. The clamping apparatus in accordance with claim 1, wherein the bolt extends along a height axis, wherein the height distance is parallel to the height axis, and in that the guide element is supported for height movement on the holding body such that, via the guide element, the pressure piece has a mobility component parallel to the height axis.

5. The clamping apparatus in accordance with claim 1, wherein the guide element is pivotably or displaceably supported relative the holding body.

6. The clamping apparatus in accordance with claim 1, wherein via the heightwise movable guide element, the clamping rail, relative to at least one of (i) the bolt and (ii) the holding body, is
pivotable, or
heightwise displaceable as a whole; or
heightwise displaceable in one or more portions thereof.

7. The clamping apparatus in accordance with claim 1, wherein via the heightwise movable guide element, an angular position of the clamping rail relative to at least one of (i) the bolt and (ii) the holding body is variable, with at least one of the following:
in a clamped state in which the clamping apparatus exerts a clamping force upon a workpiece, the clamping rail lies with its displacement axis at an acute angle to a horizontal axis of the holding body;
a maximum acute angle of the clamping rail relative to a horizontal axis of the holding body is such that the clamping rail or the pressure piece will not in any displacement position of the clamping rail project beyond an underside of the holding body which is provided for contact of the holding body against the plate;
a maximum acute angle relative to the horizontal axis is less than or equal to 15°, and in particular less than or equal to 10°, and in particular less than or equal to 7°, and in particular less than or equal to 6°, and in particular less than or equal to 5°.

8. The clamping apparatus in accordance with claim 1, wherein the guide element is pivotably supported on the holding body via a pivot bearing, with at least one of the following:
a pivot axis of the pivot bearing is oriented transversely and in particular perpendicularly to the displacement axis of the clamping rail;
a pivot axis of the pivot bearing is oriented transversely and in particular perpendicularly to a direction of the height distance;
a pivot axis of the pivot bearing is oriented transversely and in particular perpendicularly to a height axis of the bolt;
the guide element is configured in the form of a rocker;
the clamping rail is positioned between the pivot bearing and the bolt, with respect to the height distance;
the pivot bearing is arranged such that a projection of the pivot bearing in a direction of the height distance lies on the bolt or at a distance transverse to a height axis of the bolt of less than 2 cm from the bolt.

9. The clamping apparatus in accordance with claim 1, wherein the guide element is heightwise displaceable relative to the holding body and is supported for displacement relative to the holding body in a direction transverse to the displacement axis of the clamping rail.

10. The clamping apparatus in accordance with claim 1, wherein a displacement bearing is provided on which the guide element is supported for displacement relative to the holding body.

11. The clamping apparatus in accordance with claim 10, wherein the displacement bearing has at least one elongated hole on which a pin is guided, wherein (i) the pin is connected to the guide element in translationally fixed relation thereto and the at least one elongated hole is translationally fixed relative to the holding body, or (ii) the pin is translationally fixed relative to the holding body and the at least one elongated hole is connected in translationally fixed relation to the guide element.

12. The clamping apparatus in accordance with claim 11, wherein at least one of the following applies:
a plurality of elongated hole are provided which are spaced apart in a direction parallel to the displacement axis of the clamping rail;
an elongated hole has an elongated hole axis which is arranged at an acute angle to a horizontal axis of the holding body, in particular wherein the acute angle is in the range between 2° and 25°;
(i) in the case of a plurality of elongated holes, these have identical configurations and an angular position of the clamping rail relative to the bolt does not change when the guide element is displaced heightwise, or (ii) in the case of a plurality of elongated holes, these are at least one of (i) arranged and (ii) formed differently and an angular position of the clamping rail relative to the bolt changes when the guide element is displaced heightwise;
the guide element has a movement component parallel to the horizontal axis of the holding body;
the at least one elongated hole is arranged at a housing which is connected to the holding body or is part of the holding body.

13. The clamping apparatus in accordance with claim 1, wherein the holding body has an underside with a contact surface for contact against the plate, wherein the bolt extends transversely away from the underside.

14. The clamping apparatus in accordance with claim 1, wherein a clamping lever is provided which is pivotable relative to the holding body, with at least one of the following:
a pivot axis of the clamping lever is oriented transversely to the displacement axis of the clamping rail;
a pivot axis of the clamping lever is oriented parallel or at an acute angle of less than 15° relative to a height axis of the bolt;
a pivot axis of the clamping lever is oriented transversely to a contact surface of the holding body against the plate.

15. The clamping apparatus in accordance with claim 14, wherein the clamping lever is arranged at the guide element and is movable with the guide element.

16. The clamping apparatus in accordance with claim 14, wherein the clamping lever is located at the holding body and the guide element is heightwise movable relative to the clamping lever.

17. The clamping apparatus in accordance with claim 14, wherein the clamping lever has at least a first position in which a displacement movement of the clamping rail along the displacement axis is released, and has a second position which is a blocking position in which the displacement of the clamping rail in a backward direction is blocked.

18. The clamping apparatus in accordance with claim 17, wherein in the second position, a movement of the clamping lever out of the second position is blocked.

19. The clamping apparatus in accordance with claim 14, wherein at least one advance element is provided which is associated with the clamping lever and via which the clamping lever acts upon the clamping rail, with at least one of the following:
the clamping rail is passed through an opening of the at least one advance element;
the at least one advance element is configured in the form of a plate, and in particular a sheet metal plate;
in a first position of the clamping lever, the at least advance element is positioned such that the clamping rail is freely displaceable along the displacement axis;
starting from the first position of the clamping lever, a pivoting of the clamping lever effects canting of the at least one advance element relative to the clamping rail and effects advancement of the at least one advance element, and hence of the clamping rail along the displacement axis.

20. The clamping apparatus in accordance with claim 19, wherein connected to the clamping lever in rotationally fixed relation therewith is an operative element which acts upon the at least one advance element, wherein the operative element effects canting of the at least one advance element relative to the clamping rail and effects longitudinal displacement of the clamping rail in the displacement axis.

21. The clamping apparatus in accordance with claim 20, wherein the operative element acts directly upon the at least one advance element, and in particular contacts same.

22. The clamping apparatus in accordance with claim 20, wherein the operative element acts directly upon the guide element, wherein the guide element acts directly upon the at least one advance element, and in particular contacts same, and wherein the operative element effects longitudinal displacement of the guide element.

23. The clamping apparatus in accordance with claim 20, wherein the operative element is configured as an eccentric.

24. The clamping apparatus in accordance with claim 20, wherein at least one of the following applies:
the operative element is rotatably supported on a rotary bearing which is in particular a sliding bearing;
the operative element has an outer contour which is cylindrical;
the operative element has a cutout, wherein, in a first position of the clamping lever, a region of the guide element or the at least one advance element lies in the cutout and is in particular in contact against a wall of the cutout, wherein in the first position of the clamping lever, the at least one advance element is non-canted relative to the clamping rail;
in the first position of the clamping lever, the wall is oriented perpendicularly to the clamping rail;
the wall has a planar configuration, and a movement of the clamping lever out of the first position effects movement of the wall and an eccentric action upon the at least one advance element, which causes the at least one advance element to be canted relative to the clamping rail and causes the at least one advance element to be displaced;
the cutout has a shape of a segment of a circle;
a second position of the clamping lever is defined by the at least one advance element being in contact against an outer contour of the operative element, outside the cutout.

25. The clamping apparatus in accordance with claim 14, wherein at least one of the following applies:
the clamping lever is positioned above the holding body, relative to a height direction of the height distance;
when the clamping apparatus is fixed against the plate, a pivoting plane of the clamping lever is parallel to the plate or lies at an acute angle of less than 10° to the plate.

26. The clamping apparatus in accordance with claim 1, wherein the guide element is supported relative to the holding body via at least one spring device.

27. The clamping apparatus in accordance with claim 26, wherein a first spring device is arranged and configured such that it holds at least one of (i) the guide element and (ii) an advance element in a first position which is a non-clamping position and in which the clamping rail is freely displaceable, and wherein a spring force of the first spring device must be overcome in order to effect movement out the first position.

28. The clamping apparatus in accordance with claim 26, wherein a second spring device is arranged and configured such that, in a clamping position, the guide element is supported on the holding body via the second spring device and the second spring device is tensioned.

29. The clamping apparatus in accordance with claim 28, wherein a spring force of the second spring device is fixably adjustable, with at least one of the following:
a contact element is provided for the second spring device, which contact element is arranged at the holding body and which is fixably adjustable in its position relative to the holding body;
the clamping rail is passed through the contact element;
the contact element is operable from outside the holding body;
the contact element is configured as a rotary element.

30. The clamping apparatus in accordance with claim 1, wherein the bolt is fixably removably arranged at the holding body.

31. The clamping apparatus in accordance with claim 30, wherein an insertion guide is arranged at the holding body and wherein the bolt has a counter element to the insertion guide, wherein, when the counter element is arranged in the insertion guide, the bolt is held in place to the holding body.

32. The clamping apparatus in accordance with claim 30, wherein the bolt is fixably removably held in place to the holding body via a threaded connection.

33. The clamping apparatus in accordance with claim 30, wherein a set of bolts is provided, wherein different bolts have at least one of (i) different diameters and (ii) different lengths.

34. The clamping apparatus in accordance with claim 1, wherein the bolt has at least a first segment and a second segment, and wherein an expanding element is arranged at the guide element, which expanding element is heightwise movable with the guide element, and wherein the expanding element is positioned between the first segment and the second segment of the bolt.

35. The clamping apparatus in accordance with claim 34, wherein the expanding element is arranged and formed such that a height movement of the guide element in a direction towards the bolt causes the bolt to expand transversely to a direction of insertion of the bolt into the associated opening of the plate.

36. The clamping apparatus in accordance with claim 34, wherein a clamping lever is connected to the guide element in rotationally fixed relation therewith.

37. The clamping apparatus in accordance with claim 34, wherein the guide element is rotatably arranged on the holding body, with at least one of the following:
an axis of rotation of the guide element is transverse to the displacement axis of the clamping rail;
an axis of rotation of the guide element is at least approximately parallel to a direction of the height distance;
an axis of rotation of the guide element is at least approximately parallel to a height axis of the bolt;
an axis of rotation of the guide element is at least approximately parallel to a direction of insertion of the bolt into the opening of the plate.

38. The clamping apparatus in accordance with claim 37, wherein the guide element is supported on the holding body via a thread, and via a trapezoidal thread in particular.

39. The clamping apparatus in accordance with claim 31, wherein the expanding element is connected in rotationally fixed relation to a clamping lever or to the guide element, wherein a pivoting movement of the clamping lever out of a first position in which the clamping rail is freely displaceable relative to the guide element, has the following effects:
lowers the expanding element in a height direction;
expands the bolt;
cants at least one advance element relative to the clamping rail;
advances the at least one advance element and thereby advances the clamping rail.

40. The clamping apparatus in accordance with claim 34, wherein arranged at at least one of (i) the guide element and (ii) the clamping lever is a disc element which acts upon at least one advance element for the clamping rail.

41. A clamping apparatus for a plate, comprising
a holding body at which a bolt is arranged for entering into an opening of the plate,
a clamping rail which is linearly displaceable relative to the holding body along a displacement axis, and
a clamping lever for actuating a displacement movement of the clamping rail,
wherein the bolt has at least a first segment and a second segment, and
wherein the clamping lever has associated therewith an expanding element which is arranged between the first segment and the second segment of the bolt, and
wherein the expanding element is coupled to the clamping lever such that pivoting movement of the clamping lever effects expansion of the bolt by the expanding element.

42. The clamping apparatus in accordance with claim 41, wherein the expanding element is supported for height movement in a height axis relative to the holding body.

43. The clamping apparatus in accordance with claim 42, wherein the expanding element is arranged and configured such that a height movement in a direction towards the plate effects expansion of the bolt transversely to a direction of insertion of the bolt into the associated opening.

44. The clamping apparatus in accordance with claim 41, wherein the expanding element is connected to the clamping lever in rotationally fixed relation therewith.

45. The clamping apparatus in accordance with claim 41, wherein the clamping lever is rotatably arranged on the holding body.

46. The clamping apparatus in accordance with claim 45, wherein the clamping lever is supported on the holding body via a thread.

47. The clamping apparatus in accordance with claim 41, wherein a rotary movement of the clamping lever out of a first position in which the clamping rail is freely displaceable has the following effects:
moves the expanding element with action on the bolt and, for example, lowers the expanding element in a height direction;
expands the bolt;
cants at least one advance element relative to the clamping rail;
advances the at least one advance element and thereby advances the clamping rail.

48. The clamping apparatus in accordance with claim 41, wherein a disc element is connected to the clamping lever which acts on at least one advance element for the clamping rail.

49. A contact apparatus for a plate, comprising
a holding body,
a bolt which is arranged at the holding body and is provided for entering into an opening of the plate, and
a contact element having a contact surface for a workpiece,
wherein the contact element is supported for height movement relative to the holding body, wherein, relative to a height axis, a height distance of the contact surface to at least one of (i) the bolt and (ii) the holding body is variable.

50. The contact apparatus in accordance with claim 49, wherein the contact element is pivotable via a pivot bearing, or the contact element is supported for height displacement relative to the holding body via a displacement bearing.

51. The contact apparatus in accordance with claim 50, wherein the displacement bearing has at least one elongated hole and wherein the contact element is supported for displacement relative to the holding body in a direction transverse to the height axis.

52. The contact apparatus in accordance with claim 49, wherein a spring device is provided by way of which the contact element is supported on the holding body, wherein the spring device holds the contact element in a first position and a spring force of the spring device needs to be overcome for moving the contact element out of the first position.

53. The contact apparatus in accordance with claim 49, wherein the contact element is heightwise movable such that in a heightwise moved position of the contact element a hold-down force acts upon at least one of (i) the holding body and (ii) the bolt.

54. The contact apparatus in accordance with claim 49, wherein the contact element has a second position in which the contact element has a maximum height position relative to a first position, wherein the contact surface is, in the height axis, in closer proximity to at least one of (i) the bolt and (ii) the holding body in the second position than in the first position.

55. The contact apparatus in accordance with claim 54, wherein a contact device is provided which predetermines at least one of (i) the first position and (ii) the second position of the contact element by contact of the contact element and wherein the contact device is arranged or formed at the holding body.

56. A method for clamping at least one workpiece between a clamping apparatus and a contact apparatus against a plate,
wherein the clamping apparatus comprises a first holding body, a first bolt which is arranged at the first holding body, and a first contact region for at least one workpiece, and wherein the first bolt is entered into a first opening of the plate, and
wherein the contact apparatus comprises a second holding body, a second bolt which is arranged at the second holding body, and a second contact region for at least one workpiece, and wherein the second bolt is entered into a second opening of the plate, wherein at least one of the following applies:
the first contact region is heightwise movable relative to at least one of i) the first holding body and ii) the first bolt, and a hold-down force is generated at the clamping apparatus in a direction towards the plate when the at least one workpiece is clamped;
the second contact region is heightwise movable relative to the second holding body, and a hold-down force is generated at the contact apparatus in a direction towards the plate when the at least one workpiece is clamped;
the first bolt is expandable and expansion is effected when the at least one workpiece is clamped.

57. The method in accordance with claim 56, wherein a clamping of the at least one workpiece between the contact apparatus and the clamping apparatus is actuated via a clamping lever at the clamping apparatus.
